(19) United States
(12) Patent Application Publication
(10) Pub. No.: US 2023/0172252 A1
(43) Pub. Date: Jun. 8, 2023

(54) METHOD FOR PRODUCING EMULSIONS

(71) Applicant: EMULCO LABORATORIES C.V.B.A., Gent (BE)

(72) Inventors: Alexandra Victoria BAYLES, Zurich (CH); Martin HOFMANN, Zurich (CH); Jan VERMANT, Zurich (CH)

(21) Appl. No.: 17/995,488

(22) PCT Filed: Apr. 9, 2021
(86) PCT No.: PCT/EP2021/059340

§ 371 Date: Oct. 5, 2022

(30) Foreign Application Priority Data
Apr. 10, 2020 (EP) 20169207.6

(51) Int. Cl. A23L 35/00; B01F 23/41

(52) U.S. Cl. CPC A23L 35/10; B01F 23/4105

(57) ABSTRACT

The current invention relates to a method for producing emulsions using a layer multiplayer comprising the steps of: providing at least two immiscible fluid streams, combining said immiscible fluid streams to a focused total fluid stream, and subsequently carrying out baker's transformations on said total fluid stream, said baker's transformation comprises: (i) stretching and cutting said total fluid stream; (ii) recombining said total fluid stream. The present invention further relates to the use of said method for food grade, polymer, cosmetic and pharmaceutical products. The present invention further relates to said food grade, polymer, cosmetic and pharmaceutical products.

### FIELD OF THE INVENTION

The invention pertains to the technical field of methods for preparing emulsions. More specifically, the present invention relates to a new method for producing emulsions. The present invention also relates to a method to produce dispersions. Furthermore, the invention relates to the emulsions produced by said method. Lastly, the present invention also relates to emulsions of foodstuff, in particular dairy and sauces, polymer emulsions, cosmetics and pharmaceuticals.

### BACKGROUND

A layer multiplier is known from U.S. Pat. No. 9,636,646 B2. It comprises an inlet for a flow of multilayered flowable material, a distribution manifold into which the inlet debouches, a number >2 of separate splitting channels extending from the distribution manifold, a recombination manifold into which the splitting channels debouch, an outlet in one end of the recombination manifold, and the distribution manifold is arranged in an opposing relationship with the recombination manifold. Furthermore, it discloses the Peelincx mixer.

This layer multiplier is known for the generation of a multilayered structure. However, a multilayered structure is not an emulsion.

The use of a micro mixer for the production of formulations is known from EP 1 658 128. A disadvantage of this disclosure is that micromixers with precision-engineered micro mixers need to be used. This is difficult to scale up to higher volumes of production.

The use of a micromixer for the continuous production of nanoparticles is known from EP 1 180 062. A disadvantage of the present disclosure is that no emulsions as such as produced. Furthermore, the present invention uses micromixers to produce low volumes of product. The process is not well-suited to upscaling.

### SUMMARY OF THE INVENTION

The present invention and embodiments thereof serve to provide a solution to one or more of above-mentioned disadvantages. To this end, the present invention relates to a method according to claim 1.

Compared to mechanical mixers, which require a lot of energy for viscous substances, the present invention has lower energy requirements and operational costs. Furthermore, the particle size of the dispersed phase can be controlled to some extent by controlling said flow. Compared to micro mixers, small channel size is not required. Instead, the layer multipliers can obtain fluid lamellae with dimensions significantly smaller than the channel size. This means the present method does not require micro technology or precision engineering to produce submillimeter channels. Additionally, the energy required for mixing can be optimized as flow is controlled.

Lastly the method according to the present invention is continuous. It is thus suitable for a continuous production process, rather than a batch-based production process. This is advantageous as cleaning and operating costs are reduced, losses due to miss-matching batch size are also reduced. It allows the continuous production of high-volume products. This is particularly advantageous for food grade emulsions such as butter, margarine and homogenization of milk.

Preferred embodiments of the device are shown in any of the claims 2 to 8. A specific preferred embodiment relates to an invention according to claim 2.

Layer multipliers can be placed after one another to carry out subsequent baker's transformations. This ensures easy scale-up. Furthermore, the capital costs for the layer multipliers can be reduced by repeatedly using the same type of multiplier.

In a second aspect, the present invention relates to the use according to claims 9-11. The present method is advantageous due to its ability to scale up and reduce energy requirements. In particular in the food, cosmetics and pharmaceutical industries mechanical mixers and similar inefficient methods are often used to produce emulsions.

In a third aspect the present invention relates to an emulsion according to claim 12. In particular this relates to food grade emulsions such as margarine, butter, homogenized milk, vinaigrette and mayonnaise, as well as polymer emulsions, cosmetic emulsions and pharmaceutical emulsions. The method can be implemented into existing production lines. It saves significant amounts of energy. The resulting emulsions have a more narrow particle size distribution. That is to say, they are more monodisperse. This is advantageous as it can be employed to optimize shelf-life, which is particularly desirable for perishables such as food, cosmetics and pharmaceutical products. It can also be used to optimize rheology. This is relevant for processing and/or packaging downstream (e.g. filling containers) as well as for the performance.

### DESCRIPTION OF FIGURES

FIG. 1 displays schematically an embodiment of flow division employed to create a multi-layered structure according to the method of the present invention.

FIG. 2 displays schematically an embodiment of collapsing a multi-layered structure into an emulsion according to present invention.

FIG. 3 shows an embodiment of modular plates from which a layer multiplier suitable for performing subsequent baker's transformation according to the present invention can be created.

FIG. 4 shows an embodiment of modular plates suitable to collapse a multi-layered structure through step-emulsification according to the present invention.

FIG. 5 shows an embodiment of modular plates suitable to create elongational or extensional flow, in order to collapse a multi-layered structure according to the present invention.

### DETAILED DESCRIPTION OF THE INVENTION

The present invention concerns a method for the production of emulsions.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

“Micromixer” refers to miniaturized mixing devices for at least two different miscible or immiscible phases, which could be liquids, solids, or gases. The characteristic channel size of micromixers is in the submillimeter range and require usually microtechnology and/or precision engineering. Micromixers are classified either as active or passive.

“Active micromixer” refers to a micromixer that uses an external force to improve mixing in a micromixer. Examples, but not limited to, of external forces or energy sources are acoustic, thermal, magnetic, dielectrophoretic, pressure disturbance, movable/compliant walls, . . . . External force does not include mechanical impellers, rotors and similar mechanical mixers.

“Passive micromixer” refers to a micromixer that does not require external energy for mixing, but relies on controlled flow for mixing.

“Baker's transformation” refers to a mixing operation named after the way bakers prepare dough. The material to be mixed is stretched, cut in two and subsequently stacked or folded on top of each other. Repeating the sequence of stretching-cutting-stacking/folding leads to striated/laminated and eventually homogenized material. The number of striations increases exponentially with each step.

“Chaotic advection” as used herein describes mixing through a quasi-unpredictable flow regime. Good mixing is usually associated with turbulent flows at high Reynolds numbers due to the quasi-unpredictable nature of flowlines and eddies associated with turbulent flows. However quasi-unpredictable flowlines can however also occur in laminar flow conditions at low Reynolds numbers and thus low energy consumption. ‘Chaotic’ flowlines occur when a material is stretched during rotation and folded back on top of each other. It thus require different flow types occurring in the mixing unit. This process resembles a non-ideal baker's transformation. The number of striations also increased exponentially, but are formed in a complex pattern.

“Flow types” as used herein refer to extensional and rotational flow. The flow of a material can be decomposed in two flow types: “extensional flow” and “rotational flow”. In “extensional flow” or “elongational flow”, a material is elongated/compressed in the flow direction. Eg flow through a tapered pipe gives rise to extensional flow components. It is described by the strain rate tensor. A rotational flow rotates a fluid particle around its center of mass. It is described by the vorticity tensor. A solid-body rotation is a rotation flow; the carriage in a Ferris wheel undergo a irrotational motion, although they move along a circular flow path. Simple shear flow, e.g. flow through a pipe, is a combination of extensional and rotational flow of equal strength.

“Flow strength” is defined as the magnitude of the in-plane components of the velocity tensor. For simple shear flow, it is equal to the shear rate.

“Static mixer” is a flow-through device inducing mixing without moving parts. Passive micromixers are an example of static mixers, but static mixers are not limited by small characteristic channel sizes. A special class of static mixer, called “fractal mixers” or “layer multipliers”, are designed based on the Baker's transformation and operate usually at low Reynolds number (laminar flow). As such a layer multiplier and a fractal mixer can be considered as synonyms. Fractal mixers thus apply a sequence of different flow types and strengths to achieve this transformation (stretching, cutting, stacking/folding). Fractal mixers differ in geometric shape and hence in the way they effectively and efficiently can apply the Baker's transformation, albeit via chaotic advection. It should be noted that the layers as described herein do not need to be parallel. Tree or dendritic repetitive structures created by the same transformations also fall within the present invention.

The term “particle size” is used as a generic term for both the size of solid particles in dispersion and the size of liquid droplets in emulsion. The term “average particle size” is also to be understood as the term “mean particle size”.

“Phase inversion” is a process in which the structure of an emulsion inverts, i.e. when the continuous phase becomes the dispersed phase and vice versa. This can be achieved by a change of any variable such as the temperature, pressure, salinity, use of stabilizers or surfactants or the proportion of oil and water.

A “dispersion” is a system in which discrete particles of one material are dispersed in a continuous phase of another material. The two phases may be in the same or different states of matter. They are different than solutions, where dissolved molecules do not form a separate phase from the solute.

An “emulsion” is a dispersion of two or more liquids that are normally immiscible. The term emulsion refers to a dispersion where both phases, dispersed and continuous, are liquids. In an emulsion, one liquid (the dispersed phase) is dispersed in the other (the continuous phase). Emulsions, being liquids, do not exhibit a static internal structure. Two liquids can form different types of emulsions. As an example, oil and water can form, first, an oil-in-water (O/W) emulsion, wherein the oil is the dispersed phase, and water is the dispersion medium. Second, they can form a water-in-oil (W/O) emulsion, wherein water is the dispersed phase and oil is the external phase. Multiple emulsions are also possible, including a “water-in-oil-in-water (W/O/W)” emulsion and an “oil-in-water-in-oil (O/W/O)” emulsion. Multiple emulsions are often equivalently described as “complex emulsions” in related literature.

“Radial mixing” is defined by rotational circulation of a processed material around its own hydraulic center in each channel of the mixer, which causes radial mixing of the material. Radial mixers are a typically static mixers. However said radial mixers are not fractal mixers and do not produce striated or laminated flow.

A “yield stress fluid” is able to flow (i.e., deform indefinitely) only if they are submitted to a stress above some critical value. Yield stress fluids are encountered in a wide range of applications: toothpastes, cements, mortars, foams, muds, mayonnaise, etc.

In a first aspect, the invention provides/relates to a method for producing emulsions using a layer multiplayer comprising the steps of:
providing at least two immiscible fluid streams,
combining said immiscible fluid streams to a focused total fluid stream, and
Subsequently carrying out baker's transformations on said total fluid stream, said baker's transformation comprises:
   i. stretching and cutting said total fluid stream; and
   ii. recombining said total fluid stream.

The baker's transformation as used herein is particularly advantageous. It gives rise to a continuous process that can easily be scaled up and down by respectively increasing or decreasing the amount of baker's transformations that are performed subsequently and/or by adjusting the mixer's cross section area. It is understood that adjusting the mixer's cross sectional area does impact the flow regime therein. Furthermore, the present method is significantly more energy efficient than mechanical mixers and rotational static mixers.

The skilled person understands that said fluid streams can be cut prior or after stretching when performing a baker's transformation. Cutting as described herein generally refers to splitting a fluid stream into at least two streams.

Advantageously, each baker's transformation can be performed by addition of an extra layer multiplier unit. This allows easy up and downscaling of processes. Furthermore, it shows that no precision engineering is required. Lastly, the cost for these layer multiplier units can be reduced by using the same unit several times subsequently.

In a preferred embodiment, at least 2 subsequent baker's transformations are carried out, more preferably at least 3, more preferably at least 4, more preferably at least 5, more preferably at least 6 baker's transformations are carried out.

In a preferred embodiment, at most 20 subsequent baker's transformations are carried out, more preferably at most 18, more preferably at most 16, more preferably at most 14, more preferably at most 12, more preferably at most 10, more preferably at most 8 subsequent baker's transformations are carried out.

In a preferred embodiment, between 2 and 20 subsequent baker's transformations are carried out, preferably 3 to 10 subsequent baker's transformations, more preferably 4 to 8.

The inventors have found that these amounts of baker's transformation is a good optimum between sufficient mixing to obtain emulsions, preferably monodisperse emulsions, and energy requirement. The energy requirement herein is generally the result of the pressure drop in each layer multiplier unit.

The first step according to creating an emulsion according to the present invention comprises the production of a multi-layered fluid structure comprising an first and a second phase. These phases need to be immiscible, that is to say remain separate liquid phases.

In an embodiment, the invention relates to a method according to the first aspect, the present invention relates to a method for preparing an emulsion comprising the steps:
mixing a first phase and a second phase in a layer multiplier to produce a multilayered fluid structure, by subsequently carrying out baker's transformations, and
collapsing said multilayered fluid structure, thereby dispersing the second phase in the first phase creating an emulsion.

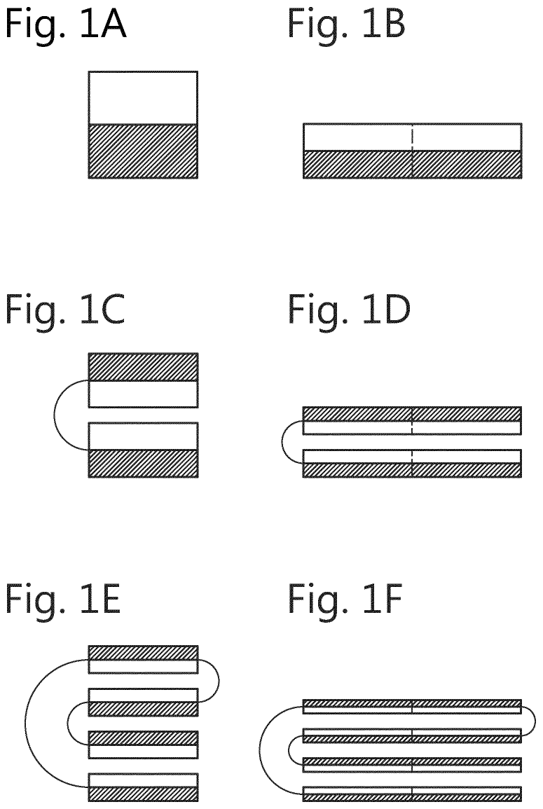

In FIG. 1, the principle of flow division on two immiscible liquids flowing through a layer multiplier is shown. In the layer multiplier, both the first and second phase are combined, stretched and consequently folded, stacked or otherwise recombined so that more layers are formed. These layers can again be stretched and recombined so each pass through the layer multiplier multiplies the amount of layers in the multi-layered structure.

In a preferred embodiment, said baker's transformation comprises the steps of:
i. stretching and cutting said total fluid stream; and
ii. folding said total fluid stream.

This embodiment is shown in FIG. 1. Characteristic about folding is that the fluid lamellae on the fold are both of the same fluid. This means these fluid lamellae, after recombination, will mix. This is advantageous as the folding interface will not be noticeable after folding. This does lead to less efficient multiplication of fluid lamellae, as the lamellae on the fold combine to one phase.

In another preferred embodiment, said baker's transformation comprises the steps of:
i. stretching and cutting said total fluid stream; and
ii. stacking said total fluid stream.

Characteristic about stacking is that the fluid lamellae on the fold are immiscible. This is more energy efficient than folding as each created fluid lamellae remains contained between other fluid lamellae of immiscible fluids. Consequently there is no reduction in fluid lamellae as seen for folding.

In a preferred embodiment, fluid streams are stretched by tapering the cross-sectional area wherein the fluid stream(s), in particular the total fluid stream, is flowing. This is advantageous as it provides a minor mixing effect without requiring rotation or turbulence, thus improving mixing properties and reducing layer distortion.

A multi-layered structure as such is not an emulsion. The generated multi-layered structure needs to collapse into an emulsion.

This can be done through various methods. The generated multi-layered structure may naturally collapse into an emulsion due to the inherent instability of a multi-layered fluid structure. Repeatedly performing baker's transformations will eventually lead to an emulsion; as the multi-layered structure cannot be multiplied and remain stable indefinitely.

In another embodiment, the generated multi-layered structure can be considered a pre-mix. It can then be emulsified by supplying the multi-layered structure to another mixer, such as a conventional mechanical mixer or a rotational mixer. This is advantageous as the mechanical mixing time is significantly reduced. Consequently, properties of mechanical mixing (i.e. batch process and particle size distribution) can be obtained without the high energy costs. This is particularly advantageous for the production of food stuff, such as dairy, homogenisation of milk, butter, cheese and precursors for cheese and margarine. These products are required to conform to a strict sense of consistency by the consumer. A monodisperse emulsion may be beneficial for shelf life, but it may or may not be desired by consumers. The suggested method of pre-mixing with a fractal mixer and finishing with a traditional mechanical mixer produces an emulsion similar to those produced by solely mechanical mixing, but with significant energy savings.

One of the embodiments according to the present invention is inserting the target dispersion medium perpendicular to the multi-layered structure. This embodiment will, as example, be described in detail to explain the working principle of the method according to the first aspect of the invention. The addition of the target dispersion medium can be considered a modified catastrophic phase inversion process.

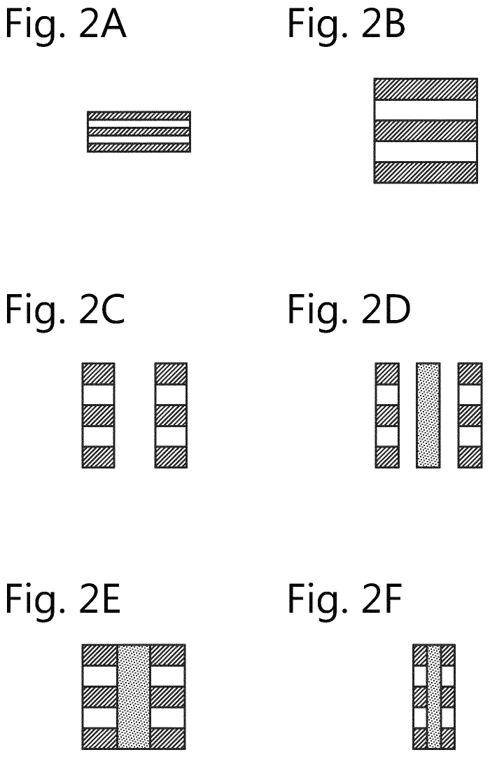

Collapsing a multi-layered structure to an emulsion is shown in FIG. 2A-2F. In FIG. 2A, a multi-layered structure is produced. This structure can be stretched as desired. In FIG. 2C, the multi-layered structure is split perpendicular to the layers of the multi-layered structure. In FIG. 2D, the target dispersion medium is inserted as monolayer, perpendicular to the layers of the multi-layered structure. When these are recombined as seen in FIG. 2E, what remains is no longer a multi-layered structure, but instead liquid threads of the to be dispersed phase are formed. The shape of which will confirm to the geometry of the container in which it is contained and/or through which it flows, such as shown in FIG. 2F. Liquid threads are in general unstable and tend to destabilize in droplets by a Plateau-Rayleigh instability. This destabilization process can be assisted by multiplying the structure in FIG. 2F in a layer multiplier.

In a preferred embodiment, the layer multiplier is a layer multiplier suitable for generating a high-viscosity multi-layered structure. Such layer multipliers are known in the prior art. In a more preferred embodiment, the layer multiplier is the layer multiplier disclosed in U.S. Pat. No. 9,636,646. It comprises an inlet for a flow of multilayered flowable material, a distribution manifold into which the inlet debouches, a number >2 of separate splitting channels extending from the distribution manifold, a recombination manifold into which the splitting channels debouch, an outlet in one end of the recombination manifold, and the distribution manifold is arranged in an opposing relationship with the recombination manifold.

In one embodiment there are >2, such as 3, 4, 5, 6, 7, 8, 9, 10 or more separate splitting channels extending between each distribution manifold and the corresponding recombination manifold. In one or several embodiments there are 4-8 splitting channels per pair of distribution manifold/recombination manifold.

In a preferred embodiment, the channels according to present invention have a cross section area of at least 0.1 mm², preferably at least 0.2 mm², more preferably at least 0.3 mm², more preferably at least 0.4 mm², more preferably at least 0.5 mm², more preferably at least 0.6 mm², more preferably at least 0.7 mm², more preferably at least 0.8 mm², more preferably at least 0.9 mm², more preferably at least 1.0 mm², more preferably at least 1.2 mm², more preferably at least 1.5 mm², more preferably at least 2.0 mm².

A particular advantage of the present invention is that sub-millimeter channels are not required. Consequently, precision-engineering is not a necessity. This can significantly reduce costs. Additionally, it can prevent blocking and clogging of said channels and facilitate cleaning

In one embodiment the layer multiplier has an overall curved shape with the inlet and the outlet respectively arranged radially inside of the splitting channels. This arrangement is space efficient in that the larger number of splitting channels may be arranged along the circumference of the layer multiplier and that the space available in the middle may be utilized for inlet(s) and outlet(s). It also facilitates stacking of several layer multipliers, one on top of the other, in a natural fashion.

In one embodiment it has proven to be beneficial for the multiplier to comprise two identical halves arranged in a 180° relationship, each half comprising a distribution chamber, splitting channels, and a recombination chamber. Using two identical halves basically cuts the average path length for a flow path through the layer multiplier in half. This shortens residence times and reduces the pressure drop. The output from each of the halves is preferably combined (stacked) before the multi-layered structure enters a consecutive multiplying step.

In one embodiment, the shape of the recombination chamber corresponds to the shape of the distribution chamber, preferably such that the shapes are identical. This offers a predictable behaviour of the layer multiplier and facilitates balancing of the system. The feature obviously also has advantages from a manufacturing standpoint. In one or more embodiments the total number of splitting channels corresponds to 2-20, such as 4, 8, 12, 16 or 20, implying 2, 4, 6, 8 or 10 per distribution channel in the recently mentioned embodiment.

In one embodiment, the layer-multiplier or layer multiplier also relates to a layer-multiplier assembly, comprising several layer multipliers of any preceding or later embodiment arranged on top of each other, optionally provided with a coupling element there between. In some embodiments the adjacent layer multipliers in the assembly may be rotated 90°, which simplifies coupling in relation to the orientation of the multilayer structure processed in the assembly.

Formation of a well-defined multi-layered fluid structure allows “geometric” control of the particle size. As long as the droplets are stable, the particle size can be chosen independent of the amount of stabilizer. In the methods according to the prior art, these parameters are frequently linked, particularly in low stabilizer regimes. That is to say, in low stabilizer regimes the amount of stabilizer determines the particle size, and adding more stabilizer would generally reduce the particle size. In high-stabilizer regimes, the particle size would be determined by the energy-input. This remains true for present invention, however the energy input can more easily be measured and estimated through the amount of splitters used and the flow strength applied. This allows “geometric” control of the particle size.

In a preferred embodiment of the present invention, the method is a continuous method, rather than a batch process. The throughput for producing emulsions of viscous phases is improved, as layer multipliers are generally faster than mechanical mixers. The present invention also allows for the production of emulsions continuously, rather than as a batch process. Furthermore, smaller droplet diameters can be produced. Additionally, a more narrow particle size distribution can be produced by controlled collapse of the multi-layered fluid structure.

In an embodiment, said first phase and said second phase comprise an aqueous and a non-aqueous phase, or a “water” and an “oil” phase. Herein, the water or aqueous phase is not necessarily H₂O, but rather the more polar of the two phases.

In a preferred embodiment, said first and/or said second phase comprise an emulsion. This is advantageous as it shows the method can easily be adapted for more complex multiphase systems. For example, O/W/O emulsions can be created by first producing an O/W emulsion, either through the method according to the present invention or through other methods, and then using said O/W emulsion as one phase, along with another oil phase, to create an O/W/O emulsion according to the first aspect of the invention. Similarly, W/O/W emulsions can be created from an aqueous phase and an W/O emulsion. This is advantageous over other methods where such simple extensions to multiphase systems cannot be made in a general sense. In another preferred embodiment, said first and/or second phase comprise a suspension or any other phase which is sufficiently fluid to be subjected to flow division, resulting in a multi-layered structure.

In a preferred embodiment, a single layer of said multi-layered structure has a thickness lower than 100 μm before collapsing, preferably an thickness lower than 50 μm, more preferably an thickness lower than 10 μm, more preferably an thickness lower than 5 μm, more preferably an thickness lower than 3 μm, more preferably an average thickness lower than 1 μm. Multi-layered structures with a thickness lower than 0.5 μm generally were unstable, and would collapse quickly.

The thickness of the layers described herein is the theoretical thickness, which can be calculated from the flow rate of the first or second phase and the number of flow divisions and the cross section area.

In a preferred embodiment, the emulsion comprises stabilizer. The stabilizer can be added to the first or the second phase. In a preferred embodiment, the stabilizer comprises a lipophilic end and a hydrophilic end. In a more preferred embodiment, the hydrophilic end is added to the more polar phase, and the lipophilic end is added to the less polar phase. Upon contact between both phases, the stabilizer is formed by reaction between the hydrophilic and lipophilic ends forming a surface-active stabilizer. with both aqueous end and non-aqueous end. This reaction speeds up as the surface between the first and second phase increases, which occurs while the multilayer is formed as the amount of layers multiplies and when said multilayer is collapsed into an emulsion.

In a preferred embodiment, the amount of stabilizer in the emulsion is less than 5% by weight, preferably less than 4%, more preferably less than 3%, more preferably less than 2%. In order to obtain sufficient shelf-life, 1 wt. % stabilizer is generally required. For applications where a long shelf-life is not required, at least 0.5% stabilizer is needed to produce the emulsion. Without sufficient stabilizer, emulsions will coalescence too quickly into two phases to be applicable for their purpose. The amount of stabilizer used should be the amount of stabilizer required to obtain an emulsion which is sufficiently stable for its purpose. Emulsions created through mechanical agitation often require additional stabilizer in order to create said emulsion, rather than stabilize it, to reduce mixing/kneading time and energy requirements. The method of the present invention circumvents these issues, allowing the production of emulsions which could not be formed through mechanical agitation.

Stabilizer is generally expensive and frequently not desired within the final product. Stabilizer or emulsifier is used to create and/or stabilize emulsions. In some conditions, the method according to the present invention allows the creation of emulsions with considerably smaller amounts of stabilizer than the use of mechanical agitators. As a result, stabilizer can be added to acquire the desired stability of the emulsion, which is often less than what is required to produce said emulsion. Determining the amount of stabilizer required to produce a (sufficiently) stable emulsion can be done through trial and error. Within the low-stabilizer regime, increasing the amount of stabilizer generally leads to smaller particle size. In the high-stabilizer regime, increasing the amount of stabilizer will not have an effect on the particle size. The method according to the invention allows production of emulsions with a droplet distribution which is geometrically controlled, rather than through the energy input and amount of stabilizer both of which cannot be decided independently and can be difficult to measure and control.

An emulsion produced with the method according to the present invention contains less stabilizer at a fixed particle size compared to mechanical agitation in the high-stabilizer regime. An emulsion produced with the method according to the present invention can have smaller droplet diameters for a fixed amount of stabilizer mechanical agitation in the high-stabilizer regime.

In a preferred embodiment, the multi-layered structure is collapsed by inserting an additional fluid perpendicular to the flow of the layers. This additional fluid is preferably the desired dispersion medium. The dispersion medium is generally the aqueous phase, but can be either phase. By inserting the dispersion medium perpendicular to the multi-layered structure, small liquid droplets are separated and surrounded by the dispersion medium. As a result, if these droplets do not quickly coalescence then an emulsion with a desired particle size distribution can be created. Furthermore, this particle size distribution is generally more narrow than distributions produced by mechanical agitation mechanisms, or rather the variation in particle size is significantly smaller than for emulsions created by addition of stabilizer and mechanical agitation. Furthermore, compared to collapsing the multi-layered structure by radial mixing, this embodiment does not force the entire target dispersion phase to undergo flow division. As less material needs to pass the layer multiplier in order to form a multi-layered structure, energy is saved and a smaller layer multiplier can be used.

In another embodiment, the multi-layered structure is collapsed by radial mixing. A radial mixing unit can be placed downstream of one or multiple layer-multiplier units. This results in a single process stream, and thus layer multiplier assembly, wherein both phases are supplied, multiplied and collapsed into an emulsion. In a further, preferred embodiment, increasing the flow rate stretches the multi-layered structure. An increased flow-rate is beneficial for radial mixing, and allows a laminar flow regime within the flow-division assembly followed by a turbulent flow regime within the radial-mixing unit. This is advantageous as it requires a single design. Furthermore this design does not comprise any moving parts, which results in fewer energy losses due to moving parts.

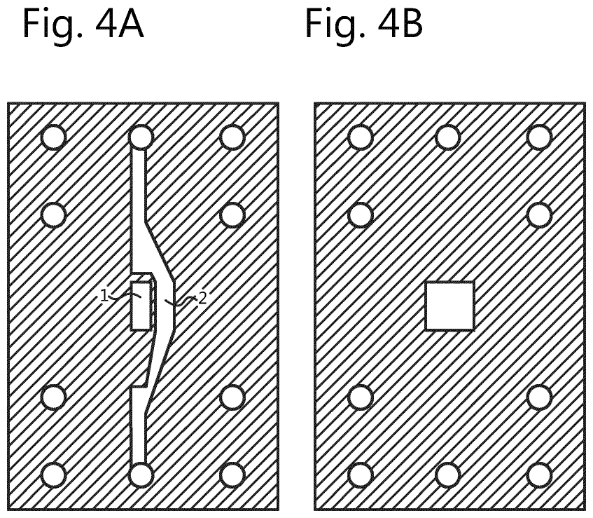

In another embodiment, the multi-layered structure is collapsed into an emulsion by a step-emulsification process. Said step-emulsification process comprises a transition from a shallow, narrow channel into a deep and wide reservoir. The abrupt, step-wise change from the shallow channel into the reservoir induces layer instabilities and layer break-up into emulsion droplets. This emulsification process can be realised using an assembly of the plates shown in FIG. 4. The multi-layered structure flows through a rectangular opening 1 in FIG. 4A into the deep reservoir of FIG. 4B to induce layer instability. A crossflow of the dispersion medium flowing in channel 2 of FIG. 4A will thus remove the formed droplets by advection. In a preferred embodiment the multi-layered structure is oriented perpendicular to the longest side of the rectangular opening 1 in FIG. 4A. In another preferred embodiment, the multi-layered structure is oriented parallel to the longest side of the rectangular opening 1 in FIG. 4A.

In an advantageous embodiment of the first aspect, the present invention relates to a method for preparing a polyisobutene (PiB) in water emulsion comprising:
combining a number of separate fluid streams of PiB and water with formation of alternating fluid lamellae of PiB and water,
focusing the alternating fluid lamellae of PiB and water with formation of a focused total fluid stream,
gradually tapering the crossflow section of said focused total fluid stream in the direction of the flow in a manner that decays said alternating polyisobutene and water fluid lamellae.

PiB in water emulsions are of an particular interest for processing and using PiB in industry. Consequently, an efficient manner by which PiB in water emulsions can be created is desired. The inventors have found that collapsing the formation of alternating fluid lamellae within a focused total fluid stream through shear flow is not efficient for viscosity ratio between PiB and water above 4. Consequently, shear flow is not suitable for obtaining PiB in water emulsions with a small average diameter. The inventors have surprisingly found that elongational or extensional flow does promote efficient droplet breakup for viscosity ratio's well above 4, including up to 10⁴. Consequently, the preferential method allows the emulsification of highly viscous PiB into water in an energy efficient manner. Furthermore, emulsions with superior properties such as smaller average diameter or better control over the particle size distribution of the emulsion is obtained.

In a further preferred embodiment, the following two steps are carried out once or several times:
gradually tapering the crossflow section of said focused total fluid stream in the direction of the flow from a first crossflow section area A₁ to a second crossflow section A₂, wherein the first crossflow section area A₁ is larger than the second crossflow section area A₂, and
abruptly expanding said second crossflow section area A₂ to a third crossflow section area A₃, wherein said third crossflow section is equal or larger than said second cross flow section area A₂.

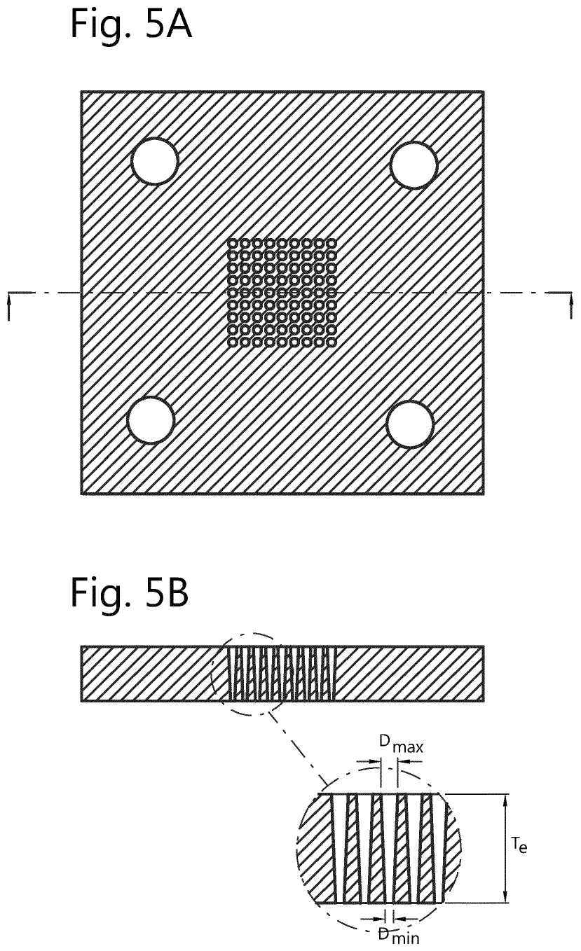

A modular plate in which the crossflow section is tapered is shown in FIG. 5A. A cross-section of this plate is shown in FIG. 5B. FIG. 5B shows a series of conical fluid passages. The fluid enters said conical passages where the diameter of the cones is at its maximum, Dₘₐₓ. It is pushed through to these cones, which are tapered in cross-section to a minimum cone diameter, Dₘᵢₙ at the other side of said plate. This creates an elongational or extensional flow regime.

In a preferred embodiment, at least one stabilizer is added to at least one polyisobutene and/or water stream. More preferably, a stabilizer is added to each polyisobutene and/or water stream. Most preferably, a stabilizer is added to each polyisobutene and water stream. Stabilizers are clearly described herein.

In a further, preferred embodiment, a first stabilizer is added to at least one water stream, and wherein a second stabilizer is added to at least one polyisobutene stream, wherein the first and the second stabilizer comprise corresponding surface active moieties, preferably said corresponding surface active moieties are an acidic and basic moieties. The use of said corresponding surface active moieties stabilizes the liquid-liquid surface. It is beneficial to the formation of alternating fluid lamellae with a low average thickness. Furthermore, it is beneficial to promoting stratified flow, and thus efficient mixing, within a static mixer or fluid multiplier as defined herein. In a further preferred embodiment, at least one polyisobutene stream comprises a fatty acid, preferably stearic acid, more preferably isostearic acid. More preferably, all polyisobutene streams comprise a fatty acid, preferably stearic acid, more preferably isostearic acid. In another preferred embodiment, at least one water stream comprises a base, preferably morpholine. More preferably, all water streams comprise a base, preferably morpholine. In a further, more preferred embodiment at least one, preferably all, polyisobutene stream(s) comprises a fatty acid, preferably stearic acid, more preferably isostearic acid and at least one, preferably all, water stream(s) comprise a base, preferably morpholine.

In a preferred embodiment, the ratio of the dynamic viscosity of a PiB stream to the dynamic viscosity of a water stream is higher than 4, preferably higher than 10, more preferably higher than 50, more preferably higher than 100, more preferably higher than 500, more preferably higher than 1.000, more preferably higher than 3.000, more preferably higher than 5.000, most preferably at least 10.000. The elongational or extensional flow conditions, created by tapering the flow cross-section in the direction of the flow, are in particular advantageous over alternative methods for large viscosity ratios. In particular, shear flow shows a significant drop-off in droplet breakup for high viscosity ratios. Subsequently, the present invention is particularly advantageous for PiB emulsions with a high viscosity ratio. Said viscosities are measured at the temperature at which the cross-section is tapered, and thus emulsification is carried out.

The temperature at which the emulsion is formed, for this process the temperature at which the cross-section tapering is carried out, is called the process temperature.

The operating temperature is higher than at least −50° C. The operating temperature is below 250° C. This requires the use of a static mixer which can withstand these temperatures. This also implies that both phases are sufficiently liquid and within the abovementioned viscosity ranges at these temperatures. In a preferred embodiment, the operating temperature is above −40° C., more preferably above −30° C., more preferably above −20° C., more preferably above −10° C., more preferably above 0° C., more preferably above 10° C., more preferably above 20° C. Operating around room temperature is advantageous as there are no heating or cooling requirements. Operating at lower or higher temperatures can be advantageous depending on the properties, such as melting temperature of the materials, of the first and second phase. In a preferred embodiment, the operating temperature is below 240° C., more preferably below 230° C., more preferably below 220° C., more preferably below 210° C., more preferably below 200° C., more preferably below 190° C., more preferably below 180° C., more preferably below 170° C., more preferably below 160° C., more preferably below 150° C., more preferably below 140° C. Higher temperatures reduce the viscosity of most materials, which may be required to allow sufficient flow division. A particular advantage of the present invention is allowing the emulsification of highly viscous PiB in water without significantly at lower process temperatures. It is known that increasing the process temperature will result in a lower viscosity for PiB, making it easier to handle and emulsify. However, increasing the temperature of the process is also a significant energy cost. This is not ecological, economical or efficient. In a preferred embodiment, the process temperature or operating temperature is lower than 100° C., preferably lower than 80° C., preferably lower than 75° C., preferably lower than 70° C., preferably lower than 65° C., preferably lower than 60° C., preferably lower than 55° C., preferably lower than 50° C., preferably lower than 45° C., preferably lower than 40° C., preferably lower than 35° C., preferably lower than 30° C., preferably lower than 25° C., preferably lower than 20° C., most preferably the process temperature or operating temperature is equal to the ambient temperature or room temperature. This results in less or no energy spent to heat up PiB and/or the entire process; leading to a more energy efficient emulsification process.

The crossflow section is gradually tapered in the direction of the flow from a first crossflow section area A₁, to a second crossflow section area A₂. In a preferred embodiment the first crossflow section area A₁ is between 10.000 and 100.000 μm². In another preferred embodiment, the second crossflow section area A₂, wherein the crossflow section area A₂ is between 2.500 and 25.000 μm². In a more preferred embodiment, the ratio of the first cross section area A₁ to the second cross section area A₂ is between 1.5 and 20, preferably between 2 and 10, more preferably between 2 and 8, more preferably between 2 and 6, most preferably between 3 and 5. In a more preferred embodiment, the first crossflow section area is between 10.000 and 100.000 μm² and the ratio of the first crossflow section area and the second crossflow section area is between 1.5 and 20, preferably between 2 and 10, more preferably between 2 and 8, more preferably between 2 and 6, most preferably between 3 and 5. Repeatedly tapering the crossflow section to produce extensional flow followed by abruptly expanding the crossflow section allows keeping the ratio between the first and the second crossflow section area within these margins. This is advantageous as it leads to a lower pressure drop over the setup or the equipment, and thus lower energy requirements.

In another preferred embodiment, the crossflow section is tapered in the direction of the flow over a length t, wherein the length t is comprised between 0.5 and 100 mm, preferably between 0.5 and 80 mm, more preferably between 0.5 and 75 mm, more preferably between 0.5 and 60 mm, more preferably between 0.5 and 50 mm, more preferably between 0.5 and 40 mm, more preferably between 0.5 and 30 mm, more preferably between 0.5 and 25 mm, more preferably between 0.5 and 20 mm, more preferably between 0.5 and 10 mm, more preferably between 1 and 10 mm. This method in particular allows for a beneficial extensional flow regime wherein a focused total fluid stream comprising alternating fluid lamellae of PiB and water decay into droplets of PiB within water. The flow regime allows for very energy-efficient and time-efficient mixing and can result in monodisperse PiB in water emulsions with a small average droplet diameter.

In another embodiment, the invention relates to a method for reducing the average droplet diameter of an emulsion, comprising the steps:
providing an emulsion, comprising droplets of a dispersed phase within a continuous phase, characterized by an average droplet diameter and a viscosity ratio of the dispersed phase to said continuous phase of at least 4, and
reducing said average droplet diameter by forcing said emulsion through a gradually tapered crossflow section of in the direction of the flow in a manner where the thickness of said alternating polyisobutene and water fluid lamellae decays.

In another preferred embodiment, the method further comprises the following steps:
gradually tapering the crossflow section of said focused total fluid stream in the direction of the flow from a first crossflow section area A₁ to a second crossflow section A₂, wherein the first crossflow section area A₁ is larger than the second crossflow section area A₂, and
abruptly expanding said second crossflow section area A₂ to a third crossflow section area A₃, wherein said third crossflow section is equal or larger than said second cross flow section area A₂.

Preferably, the following steps are carried out several times:
gradually tapering the crossflow section of said focused total fluid stream in the direction of the flow from a first crossflow section area A₁ to a second crossflow section A₂, wherein the first crossflow section area A₁ is larger than the second crossflow section area A₂, and
abruptly expanding said second crossflow section area A₂ to a third crossflow section area A₃, wherein said third crossflow section is equal or larger than said second cross flow section area A₂.

More preferably, these steps are carried out after the baker's transformations are performed. Alternatively, these steps can be carried out in between baker's transformations. These steps crate an elongational or extensional flow regime. The inventors have surprisingly found that the elongational or extensional flow regime is particularly well suited at collapsing a fluid-lamellae structure into an emulsion. Note that the energy requirement for this type of flow is exceptionally low. Furthermore, this type of flow can easily be performed in-line in a continuous manner. It thus allows for a continuous and scalable process.

A modular plate in which the crossflow section is tapered is shown in FIG. 5A. A cross-section of this plate is shown in FIG. 5B. FIG. 5B shows a series of conical fluid passages. The fluid enters said conical passages where the diameter of the cones is at its maximum, Dₘₐₓ. It is pushed through to these cones, which are tapered in cross-section to a minimum cone diameter, Dₘᵢₙ at the other side of said plate. This creates an elongational or extensional flow regime.

For layer multipliers, an average cross-sectional area Aₐᵥ for each striated fluid lamellae can be calculated. This is a theoretical value assuming no collapse of fluid lamellae. This value was found to be a good indicator of the amount of baker's transformations required to obtain an emulsion with fine particles. Aₐᵥ as calculated by method A. First, A_{eff, min} is determined. This is the minimal cross sectional area A of the total focused fluid stream of the effluent. If the cross-sectional area of the effluent stream is not constant, for example tapered for any reason, then the minimal cross-sectional area is chosen. Furthermore, the theoretical amount of fluid lamellae nₜₒₜ is calculated. For example: using five layer multiplier units, wherein each layer multiplier unit splits a stream into 6 lamellae corresponds to a total n of 6⁵ or 7776 splits. Aₐᵥ is then equal to A_{eff,min} divided by nₜₒₜ.

In a preferred embodiment of the first aspect, Aₐᵥ is lower than 0.0100 mm², preferably Aₐᵥ is lower than 0.0080 mm², more preferably Aₐᵥ is lower than 0.0060 mm², more preferably Aₐᵥ is lower than 0.0050 mm², more preferably Aₐᵥ is lower than 0.0040 mm², more preferably Aₐᵥ is lower than 0.0030 mm², more preferably Aₐᵥ is lower than 0.0020 mm², more preferably Aₐᵥ is lower than 0.0010 mm², more preferably Aₐᵥ is lower than 0.0008 mm², more preferably Aₐᵥ is lower than 0.0006 mm², more preferably Aₐᵥ is lower than 0.0004 mm², more preferably Aₐᵥ is lower than 0.0003 mm², more preferably Aₐᵥ is lower than 0.0002 mm², most preferably Aₐᵥ is lower than 0.0001 mm². In a preferred embodiment of the first aspect, Aₐᵥ is higher than 0.00001 mm², preferably Aₐᵥ is higher than 0.00002 mm², more preferably Aₐᵥ is higher than 0.00004 mm², more preferably Aₐᵥ is higher than 0.00005 mm², more preferably Aₐᵥ is higher than 0.00006 mm², more preferably Aₐᵥ is higher than 0.00007 mm², more preferably Aₐᵥ is higher than 0.00008 mm², more preferably Aₐᵥ is higher than 0.00009 mm². A sufficiently low Aₐᵥ is required to ensure sufficient mixing to obtain an emulsion. A too high Aₐᵥ leads to diminishing effectiveness of mixing and energy usage. This is because for too small Aₐᵥ, the fluid lamellae are not stable and thus tend to auto-collapse. At this point the process can be repeated to ensure good mixing, homogeneity and optimization of the particle size distribution at the cost of energy expenditure.

The Reynolds number Re as used herein is the general definition of the Reynolds number. In particular the Reynolds number Re is defined as:

$$Re = \frac{W}{{D}_{H} μ}$$

Wherein W is the mass flowrate of the fluid (kg/s),

μ is the dynamic viscosity of the fluid (Pa·s=Ns/m²=kg/(m·s)),

and D_{H} is the hydraulic diameter of the pipe (the inside diameter if the pipe is circular) (m).

For shapes such as squares, rectangular or annular ducts where the height and width are comparable, the characteristic dimension for internal-flow situations is taken to be the hydraulic diameter, DH, defined as

$${D}_{H} = \frac{4 A}{P}$$

Wherein A is the cross-sectional area, and P is the wetted perimeter. The wetted perimeter for a channel is the total perimeter of all channel walls that are in contact with the flow. This means that the length of the channel exposed to air is not included in the wetted perimeter.

In a preferred embodiment, the Reynolds number is lower than 10000, more preferably lower than 8000, more preferably lower than 6000, more preferably lower than 4000, more preferably lower than 3000, more preferably lower than 2500, more preferably lower than 2000, more preferably lower than 1500, more preferably lower than 1400, more preferably lower than 1300, more preferably lower than 1200, more preferably lower than 1100, more preferably lower than 1000. Low Reynolds numbers typically do not lead to good mixing. However, advantageously the present invention allows for good mixing with low Reynolds numbers since low Reynolds numbers promote stability of thin layers. In this case, lower Reynolds numbers also relate to reduced fluid friction and thus lower energy losses.

In a second aspect, the invention relates to the use of a method according to the first aspect to produce food grade emulsions. The method according to the present invention is particularly well suited for implementation into food processing and production industry. In particular, it can be easily scaled up and down, is a continuous process that thus does not require constant cleaning. Regardless, it can easily be cleaned and disinfected. Additionally, it can be carried out at or near room temperature, thus avoiding high temperatures which may compromise or denature the constituents. Lastly, the energy cost is a significant part of the operating costs for certain types of food stuff, such as margarine and butter. Present invention leads to a large reduction of these energy requirements and thus costs.

In a more preferred embodiment of the second aspect, the method can be used to produce margarine, dairy products such as butter or milk, sauces and dressings such as vinaigrette and mayonnaise, and so forth. The method can obviously also be used to produce pre-mixes or emulsions to be used in the production of these products. It is believed that the present invention can also be used to pre-mix air and cream, suitable to obtain whipped cream with less whipping.

In a second aspect, the invention relates to the use of a method according to the first aspect to produce food grade emulsions or cosmetic emulsions or pharmaceutical emulsions or polymer emulsions as well as precursors thereof. In a preferred embodiment of the second aspect, the invention relates to the use of a method according to the first aspect to produce food grade emulsions or cosmetic emulsions or pharmaceutical emulsions as well as precursors thereof.

The method according to the present invention is particularly well suited for implementation into food processing and production industry. In particular, it can be easily scaled up and down, is a continuous process that thus does not require constant cleaning. Regardless, it can easily be cleaned and disinfected. Lastly, the energy cost is a significant part of the operating costs for certain types of food stuff, such as margarine and butter. Present invention leads to a large reduction of these energy requirements and thus costs.

In a more preferred embodiment of the second aspect, the method can be used to produce margarine, dairy products such as butter or milk, sauces and dressings such as vinaigrette and mayonnaise, and so forth. The method can obviously also be used to produce pre-mixes or emulsions to be used in the production of these products.

It is believed that the present invention can also be used to pre-mix air and cream. This pre-mix can then be whipped to whipped cream more easily.

In another embodiment of the second aspect, the method of the first aspect can be used to produce cosmetic and pharmaceutical emulsions. In particular creams, lotions and the like can efficiently be produced. An additional advantage is that the particle size distribution as obtained with methods according to the present invention can be regulated more strictly. In particular, a more narrow particle size distribution can be obtained. These types of monodisperse emulsions generally have a longer shelf-life.

In a third aspect, the invention relates to emulsions produced by the method according to first aspect or use of said methods according to the second aspect.

These emulsions can not only be produced continuously and for lower energy costs, they also have improved properties such as more narrow particle size distributions. This is particularly advantageous in applications which benefit from monodisperse emulsions. This can improve the stability of the emulsion over time, reduce the amount of surfactant required, improve shelf-life and assure a certain consistency or “feel” to the emulsion. This is beneficial for food, cosmetics and pharmaceuticals in particular.

In a preferred embodiment of the third aspect, this relates to dairy, such as homogenized milk or butter, margarine, sauces and dressings such as vinaigrette and mayonnaise.

In a preferred embodiment of the third aspect, this relates to lotions and creams such as face creams, sun creams, moisturizer, shampoo, conditioners, topical pharmaceutical agents and so forth.

In a preferred embodiment of the third aspect, this relates to polymer emulsions. In a more preferred embodiment, this relates to polyisobutene (PiB) in water emulsions. In a more preferred embodiment, the present invention relates to an aqueous polyisobutene emulsion comprising:
66 wt. % to 95 wt. %, based on the total weight of said emulsion, of polyisobutene,
at maximum 5 wt. %, based on the total weight of said emulsion based on the total weight of said emulsion, of at least one surfactant, and
optionally 1 wt. % to 30 wt. %, based on the total weight of said emulsion, of at least one wax and/or oil,

complemented with water to 100 wt. %, wherein the average particle size of said polyisobutene emulsion is not greater than 100 μm.

PiB has a particularly high viscosity. Consequently creating PiB in water emulsions with a small particle size and a high concentration of PiB requires a large input of energy. Furthermore, it is believed that some PiB emulsions with low particle size may not be formed naturally through mechanical stirring.

A preferred embodiment of the third aspect of current invention relates to a polyisobutene emulsion with an average particle size smaller than 100 μm, it thereby provides an emulsion with good stability, good flowing parameters and relatively low viscosity and tackiness.

Aqueous emulsions comprising polyisobutene were previously limited to lower amounts of polyisobutene in order to obtain an emulsion with a particle size smaller than 100 μm. Aqueous emulsions with a low particle size of polyisobutene are desired, as these emulsions are easier to handle and process than polyisobutene pure liquid which is sticky and viscous. Increasing the amount of polyisobutene in these emulsions is advantageous as it reduces material costs, transport costs and the amount of aqueous phase required.

In a preferred embodiment, the emulsion comprises 66 wt. % to 95 wt. % based on the total weight of said emulsion, of polyisobutene, wherein the average diameter measured by laser diffraction is lower than 1 μm, more preferably lower than 0.9 μm, more preferably lower than 0.8 μm, more preferably lower than 0.7 μm, more preferably lower than 0.6 μm, more preferably lower than 0.5 μm, more preferably lower than 0.4 μm, more preferably lower than 0.3 μm, more preferably lower than 0.2 μm, more preferably lower than 0.1 μm.

Since the current invention relates to a polyisobutene emulsion with at maximum 5 wt. % of surfactants and an average particle size smaller than 100 μm, it thereby produces in an emulsion with good stability, good flowing parameters and relatively low viscosity and tackiness. Furthermore, the viscosity of an aqueous polyisobutene emulsion is related to good flowing properties and is related to the ease of handling and the energetic input that is required for manipulating said emulsion. A comparatively low viscosity generally gives rise to a polyisobutene emulsion with good flowing properties and a low energetic input for manipulation of said emulsion.

In a more preferred embodiment, said polyisobutene emulsion has an average particle size comprised between 300 nm and 25 μm. More preferably, said polyisobutene emulsion has an average particle size comprised between 400 nm and 25 μm. Even more preferably, said polyisobutene emulsion has an average particle size comprised between 500 nm and 25 μm. Most preferably, said polyisobutene emulsion has an average particle size comprised between 500 nm, 750 nm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm or any value there in between.

In a preferred embodiment, the present invention produces in an aqueous polyisobutene emulsion, whereby said wax is selected from the group comprising animal waxes, vegetable waxes, mineral waxes, petroleum waxes, polyolefin waxes, amide waxes, chemically modified waxes and combinations thereof, and whereby said oil is selected from the group comprising natural and mineral oils and combinations thereof.

Suitable waxes include both natural and synthetic waxes. Suitable waxes include animal waxes, such as bees wax, Chinese wax, wax shellac, spermaceti and wool wax; vegetable waxes such as bayberry wax, palm wax, candelilla wax, carnauba wax, castor oil wax, asparto wax, Japanese wax, jojoba oil wax, ouricury wax, rice bran wax and soybean wax; mineral waxes such as ceresin waxes, montan wax, ozokerite wax and turf wax; petroleum waxes, such as paraffin and microcrystalline waxes, and synthetic waxes, such as polyolefin waxes, including polyethylene and polypropylene waxes, polytetrafluoroethylene waxes (PTFE wax), Fischer-Tropsch waxes, stearamide waxes (including ethylene-bis-stearamide waxes), polymerized α-olefin wax, substituted amide waxes (for example, esterified or saponified substituted amide waxes) and other chemically modified waxes, such as PTFE-modified polyethylene wax, as well as combinations of the above. Preferably these waxes include paraffin wax, microcrystalline wax, Fischer-Tropsch waxes, linear and branched polyethylene waxes, polypropylene waxes, carnauba wax, ethylene-bis-stearamide (EBS) wax and combinations thereof.

Liquid Phases

The first and second phase are liquid phases which are immiscible. Various liquids and their properties which can be advantageously emulsified using the present invention will be discussed here. First, more apolar liquids which are generally termed “non-aqueous” or “oil phase” liquids will be discussed.

In an embodiment, at least one of the first and second phase comprises a polymer. In a further preferred embodiment, the polymer comprises at least one of the following: polyvinylbutyral (PVB), silicone polymers, ethylene vinyl acetate, polyolefine copolymers. In a further, more preferred embodiment polyolefine copolymers comprise copolymers of ethylene and/or propylene with an alpha-olefin such as 1-hexene or 1-octene, low density polyethylene (LDPE), Polyethylene terephthalate (PET), high density polyethylene (HDPE), polypropylene (PP), ethylene vinyl alcohol (EVOH) and polyisobutene (PiB). In a different, preferred embodiment, at least one of the first and second phase comprises an elastomeric polymer. These are advantageously emulsified for coatings, paints and so forth.

In a further, more preferred embodiment, the present invention provides a process according to the first aspect of the invention, whereby at least one of the first and second phase is viscous, preferably a viscous polymer. The viscosity is preferably at least 10.000 mPa·s, defined as the zero shear viscosity at 20° C. Preferably, said elastomeric polymer has a viscosity of higher than 12.000 mPa·s, or even higher than 15.000 mPa·s, higher than 20.000 mPa·s, higher than 30.000 mPa·s, higher than 40.000 mPa·s, or higher than 50.000 mPa·s. More preferably, said elastomeric polymer has a viscosity of 100.000 mPa·s to 1.500.000 mPa·s, and even more preferably of 120.000 mPa·s to 1.000.000 mPa·s or of 140.000 mPa·s to 800.000 mPa·s. Most preferably, said elastomeric polymer has a viscosity of 150.000 mPa·s, 200.000 mPa·s, 250.000 mPa·s, 300.000 mPa·s, 350.000 mPa·s, 400.000 mPa·s, 450.000 mPa·s, 500.000 mPa·s, 550.000 mPa·s, 600.000 mPa·s, 650.000 mPa·s, 700.000 mPa·s or 750.000 mPa·s, or any value there in between. This is especially advantageous, as the method according to the present invention produces emulsions from viscous phases with considerably lower energy requirements as required in mechanical agitation. Furthermore, less stabilizer is required. At viscosities above 50.000.000 mPa·s, repetitive flow division to obtain a multi-layered structure with sufficiently fine to collapse into an emulsion becomes unfeasible.

In another embodiment, the viscosity relates to the viscosity at operating temperature. In a preferred embodiment, the operating temperature for at least one of the first and second phase being a very viscous liquid is increased, to decrease said viscosity. This leads to lower energy requirements for flow division. The viscosity at operating temperature is preferably between 10 mPa·s and 10.000.000 mPa·s, more preferably between 20 mPa·s and 9.000.000 mPa·s, more preferably between 30 mPa·s and 8.000.000 mPa·s, more preferably between 40 mPa·s and 7.000.000 mPa·s, more preferably between 50 mPa·s and 6.000.000 mPa·s, more preferably between 100 mPa·s and 5.000.000 mPa·s, more preferably between 500 mPa·s and 5.000.000 mPa·s, more preferably between 1.000 mPa·s and 4.000.000 mPa·s, more preferably between 10.000 mPa·s and 3.000.000 mPa·s.

The operating temperature is higher than at least −50° C. The operating temperature is below 250° C. This requires the use of a static mixer which can withstand these temperatures. This also implies that both phases are sufficiently liquid and within the abovementioned viscosity ranges at these temperatures. In a preferred embodiment, the operating temperature is above −40° C., more preferably above −30° C., more preferably above −20° C., more preferably above −10° C., more preferably above 0° C., more preferably above 10° C., more preferably above 20° C. Operating around room temperature is advantageous as there are no heating or cooling requirements. Operating at lower or higher temperatures can be advantageous depending on the properties, such as the melting temperature or the degradation temperature of the materials, of the first and second phase. In a preferred embodiment, the operating temperature is below 240° C., more preferably below 230° C., more preferably below 220° C., more preferably below 210° C., more preferably below 200° C., more preferably below 190° C., more preferably below 180° C., more preferably below 170° C., more preferably below 160° C., more preferably below 150° C., more preferably below 140° C. Higher temperatures reduce the viscosity of most materials, which may be required to allow sufficient flow division.

In a preferred embodiment, the present invention provides a process according to the first aspect of the invention, whereby at least one of said first and said second phases comprise polyisobutene. Polyisobutene is a polymer obtained by polymerisation, generally by cationic polymerisation, of isobutene as fundamental monomeric unit. Polyisobutene exists in different molecular weights. Low molecular weight is understood as a molecular weight up to 25.000 g/mol, and preferably up to 10.000 g/mol; medium molecular weight is understood from 40.000 g/mol to 500.000 g/mol, and preferably from 60.000 g/mol to 200.000 g/mol; and high molecular weight is understood as 500.001 g/mol to 1.100.000 g/mol.

In a further preferred embodiment, the polyisobutene has a molecular weight higher than 200 g/mol, preferably higher than 300 g/mol, preferably higher than 400 g/mol, preferably higher than 500 g/mol, preferably higher than 600 g/mol, preferably higher than 700 g/mol, preferably higher than 800 g/mol, preferably higher than 900 g/mol, more preferably higher than 1.000 g/mol, more preferably higher than 1.500 g/mol, more preferably higher than 2.000 g/mol, more preferably higher than 3.000 g/mol, more preferably higher than 4.000 g/mol, more preferably higher than 5.000 g/mol, more preferably higher than 6.000 g/mol, more preferably higher than 7.000 g/mol, more preferably higher than 8.000 g/mol, more preferably higher than 10.000 g/mol, more preferably higher than 20.000 g/mol. Preferably the molecular weight is lower than 1.000.000 g/mol, more preferably lower than 500.000 g/mol, more preferably lower than 400.000 g/mol, more preferably lower than 300.000 g/mol, more preferably lower than 200.000 g/mol, more preferably lower than 180.000 g/mol, more preferably lower than 160.000 g/mol, more preferably lower than 140.000 g/mol, more preferably lower than 120.000 g/mol, more preferably lower than 100.000 g/mol. Higher molecular weights are currently not economical to emulsify. Lower molecular weights are not as advantageous to emulsify.

Polyisobutene with various molecular weights are commercially available. Examples of polyisobutene produced by BASF are: with low molecular weight: Glissopal®V types, such as Glissopal®V190, Glissopal®V 500, Glissopal®V 640, Glissopal®V 1500; with medium molecular weight: Oppanol®B types, such as Oppanol®B 10, Oppanol®B 11, Oppanol®B 12, Oppanol®B 13, Oppanol®B 14, Oppanol®B 15; with a high molecular weight: Oppanol®B types, such as Oppanol®B 30. Other examples include Tetrax® and Himol® products from: JXTG Nippon Oil & Energy Corporation.

Polyisobutene can be used as one type of polyisobutene or as a blend of different types of polyisobutene. It is known that the viscosity of a blend of polyisobutenes with different molecular weights is determined by the content of the various types of polyisobutene, and that the viscosity of polyisobutene increases with increasing molecular weight.

In another embodiment, at least one of the first and second phase can comprise either as component or as main constituent oils and/or waxes. Suitable oils comprise both natural and mineral oils. Natural oils comprise e.g. soybean oil, olive oil, sesame oil, cotton seed oil, castor oil, coconut oil, canola oil and palm oil, mineral oils such as paraffinic and/or naphthenic oils and petroleum jelly.

Suitable waxes include both natural and synthetic waxes. Suitable waxes include animal waxes, such as bees wax, Chinese wax, wax shellac, spermaceti and wool wax; vegetable waxes such as bayberry wax, palm wax, candelilla wax, carnauba wax, castor oil wax, asparto wax, Japanese wax, jojoba oil wax, ouricury wax, rice bran wax and soybean wax; mineral waxes such as ceresin waxes, montan wax, ozokerite wax and turf wax; petroleum waxes, such as paraffin and microcrystalline waxes, and synthetic waxes, such as polyolefin waxes, including polyethylene and polypropylene waxes, polytetrafluoroethylene waxes (PTFE wax), Fischer-Tropsch waxes, stearamide waxes (including ethylene-bis-stearamide waxes), polymerized α-olefin wax, substituted amide waxes (for example, esterified or saponified substituted amide waxes) and other chemically modified waxes, such as PTFE-modified polyethylene wax, as well as combinations of the above. Preferably these waxes include paraffin wax, microcrystalline wax, Fischer-Tropsch waxes, linear and branched polyethylene waxes, polypropylene waxes, carnauba wax, ethylene-bis-stearamide (EBS) wax and combinations thereof.

In a preferred embodiment, at least one of the first and second phase comprises vegetable oils. In a further preferred embodiment, the first and second phase comprise an aqueous phase and an oil phase, wherein said aqueous phase comprises water and said oil phase comprises a vegetable oil. In a further preferred embodiment, said vegetable oil is hydrogenated. In a further preferred embodiment, said vegetable oil comprises at least one of the following: hydrogenated coconut oil, hydrogenated palm oil, hydrogenated rapeseed oil or blends thereof. These emulsions are economically interesting as they are produced and sold on relatively large scales, and a method for continuous production thereof such as the one proposed in the present invention is desirable.

In another preferred embodiment, at least one of the first and the second phase comprises at least one of the following: hydrogenated coconut oil, hydrogenated palm oil, hydrogenated rapeseed oil or blends thereof.

In a preferred embodiment, the emulsion is essentially free of organic solvents. Solvents are generally not environmentally friendly. Furthermore, solvents are often not desired in the end-product and may need to be removed. As used herein, the phrase “essentially free of organic solvents” means that solvents are not added to the elastomeric polymer, in order to create a mixture of suitable viscosity that can be processed more easily. More specifically, “organic solvents” as used herein is meant to include any water immiscible low molecular weight organic material added to the non-aqueous phase of an emulsion for the purpose of enhancing the formation of the emulsion, and is subsequently removed after the formation of the emulsion, such as evaporation during a drying or film formation step. Thus, the phrase “essentially free of organic solvent” is not meant to exclude the presence of solvent in minor quantities in process or emulsions of the present invention. For example, there may be instances where the elastomeric polymer or stabilizer contains minor amounts of solvent as supplied commercially. Small amounts of solvent may also be present from residual cleaning operations in an industrial process. Furthermore, small amounts of solvent may also be added to the process of the present invention for purposes other than to enhance the formation of the water-continuous emulsion. Preferably, the amount of solvent present in the emulsion should be less than 5% by weight of the emulsion, more preferably the amount of solvent should be less than 2% by weight of the emulsion, and most preferably the amount of solvent should be less than 1% by weight of the emulsion. Illustrative examples of “organic solvents” that are included in the above definition are relatively low molecular weight hydrocarbons having normal boiling points below 200° C., such as alcohols, ketones, ethers, esters, aliphatics, alicyclics, or aromatic hydrocarbon, or halogenated derivatives thereof. As merely illustrative of solvents to be included in the definition of “organic solvents”, there may be mentioned butanol, pentanol, cyclopentanol, methyl isobutyl ketone, secondary butyl methyl ketone, diethyl ketone, ethyl isopropyl ketone, diisopropyl ketone, diethyl ether, sec-butyl ether, petroleum ether, ligroin, propyl acetate, butyl and isobutyl acetate, amyl and isoamyl acetate, propyl and isopropyl propionate, ethyl butyrate, pentane, hexane, heptane, cyclopentane, cyclohexane, cycloheptane, methylene chloride, carbon tetrachloride, hexyl chloride, chloroform, ethylene dichloride, benzene, toluene, xylene, chlorobenzene, and mixtures thereof with each other and/or more water soluble solvents. Furthermore, the use of an organic solvent as aqueous or non-aqueous phase is not excluded, rather its use to facilitate creating an emulsion is not required.

The present invention is not limited to water/oil emulsions or aqueous/non-aqueous emulsions. However, aqueous and non-aqueous liquids often show limited miscibility and therefor are frequently used to create emulsions.

The “aqueous phase” as described herein does not refer to water, but rather to the more hydrophilic of the two immiscible liquids which are used to form the multilayers and consequently the emulsion. Examples of hydrophilic substances suitable as aqueous phase known in the art include: water, glycerol, methanol, ethanol, n-propanol, t-butanol, ammonia, formaldehyde, acetone or acetic acid. They are generally well-suited for forming an emulsion with an oily substance or wax.

Stabilizers

Any type of stabilizer known to the person skilled in the art may be used. A stabilizer, also known as “emulgent” or “emulsifier” is a substance that stabilizes an emulsion by increasing its kinetic stability, that is to say increase the time scale on which the emulsion destabilizes, therefor increasing its shelf life.

A wide range of surface-active compounds can be used as surfactant. Preferably, the used surfactant will be selected from the group of anionic, cationic or non-ionic surface-active compounds.

Anionic surface-active compounds comprise saponified fatty acids and derivatives of fatty acids with carboxylic groups such as sodium dodecylsulphate (SDS), sodium dodecyl benzene sulphonate, sulphates and sulphonates and abietic acid.

Examples of anionic surfactants are also: carboxylates, sulphonates, sulpho fatty acid methyl esters, sulphates, phosphates.

A carboxylate is a compound which comprises at least one carboxylate group in the molecule. Examples of carboxylates are:
soaps, such as stearates, oleates, cocoates of alkaline metals or of ammonium, alkanolamines
ether carboxylates, such as Akypo® R020, Akypo® R050, Akypo® RO90

A sulphonate is a compound, that comprises at least one sulphonate group in the molecule. Examples of sulphonates are:—
Alkyl benzene sulphonates, such as Lutensit® A-LBS, Lutensit® A-LBN, Lutensit® A-LBA, Marlon® AS3, Maranil® DBX
Alkyl naphtalene sulphonates condensed with formaldehyde, lignine sulphonates, such as e.g. Borresperse NA, Tamol NH7519
Alkyl sulphonates, such as Alscoap OS-14P, BIO-TERGE® AS-40, BIO-TERGE® AS-40 CG,
Sulphonated oil, such as Turkish red oil
Olefin sulphonates
Aromatic sulphonates, such as Nekal®BX, Dowfax® 2A1

A sulphate is a compound that comprises at least one SO₄-group in the molecule. Examples of sulphates are:
Fatty acid alcohol sulphates, such as coco fatty acid alcohol sulhphate (CAS 97375-27-4), e.g. EMAL®10G, Dispersogen®SI, Elfan® 280, Mackol® 100N
Other alcohol sulphates, such as Emal® 71, Lanette® E
Coco fatty acid alcohol ether sulphates, such as EMAL® 20C, Latemul® E150, Sulfochem® ES-7, Texapon® ASV-70 Spec., Agnique SLES-229-F, Octosol 828, POLYSTEP® B-23, Unipol® 125-E, 130-E, Unipol® ES-40
Other alcohol ether sulphates, such as Avanel® S-150, Avanel® S 150 CG, Avanel® 5150 CG N, Witcolate® D51-51, Witcolate® D51-53.

A phosphate is a compound that comprises at least one PO₄-group in the molecule. Examples of phosphates are:
Alkyl ether phosphates, such as Maphos® 37P, Maphos® 54P, Maphos® 37T, Maphos® 210T, Maphos® 210P
Phosphates such as Lutensit A-EP
Alkyl phosphates

The anionic surfactants are preferable added to salt. Salts are preferably alkaline metal salts, such as sodium, potassium, lithium, ammonium hydroxylethyl ammonium, di(hydroxyethyl)ammonium and tri(hydroxyethyl) ammonium salts or alkanolamine salts.

Cationic surface-active compounds comprise dialkyl benzene alkyl ammonium chloride, alkyl benzyl methyl ammonium chloride, alkyl benzyl dimethyl ammonium bromide, benzalkonium chloride, cetyl pyridinium bromide, C₁₂, C₁₅, or C₁₇ trimethyl ammonium bromides, halide salts of quaternary polyoxy-ethylalkylamines, dodecyl benzyl triethyl ammonium chloride and benzalkonium chloride.

Examples of cationic surfactants are also: quaternary ammonium compounds. A quaternary ammonium compound is a compound that comprises at least one R₄N⁺-group in the molecule. Examples of counter ions that can be used in quaternary ammonium compounds are:
Halides, methosulphates, sulphates and carbonates of coco fat or cetyl/oleyl trimethyl ammonium.

Preferably, the following cationic surfactants are used:
N,N-dimethyl-N-(hydroxy-C₇-C₂₅-alkyl)ammonium salts
Mono- and di(C₇-C₂₅-alkyl) dimethyl ammonium compounds
Ester quats, especially mono-, di- and trialkanol amines, quaternary esterificated with C₈-C₂₂ carboxylic acids.
Imidazolin quats, especially 1-alkylimidazolinium salts.

A betaine surfactant is a compound that, under conditions of use, comprises at least one positive charge and at least one negative charge. An alkyl betaine is a betaine surfactant that comprises at least one alkyl unit per molecule. Examples of betaine surfactants are:
Cocamidopropylbetaine, such as MAFO® CAB, Amonyl® 280BE, Amphosol® CA, Amphosol® CG, Amphosol® CR, Amphosol® HCG, Amphosol® HCG-50, Chembetaine® C, TEGO®-Betain F 50, and aminoxides such as alkyl dimethylamineoxide.

Non-ionic surfactant comprise polyvinyl alcohol, poly-acrylic acid, methalose, methyl cellulose, ethyl cellulose, propyl cellulose, hydroxy ethyl cellulose, carboxymethyl cellulose, natural gum, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether and dialkylphenoxy poly(ethyleneoxy) ethanol.

Non-ionic surfactant have a neutral, polar and hydrophilic head that makes non-ionic surfactant water-soluble. Such surfactants adsorb at surfaces and aggregate to micelles above their critical micelle concentration. Depending on the type of head, different surfactant can be identified, such as (oligo)oxyalkylene groups, and especially (oligo)oxyethylene groups, (polyethylene)glycol groups and carbohydrate groups, such as alkyl polyglucosides and fatty acid N-methyl glucamides.

Alcohol phenolalkoxylates are compounds that can be produced through addition of alkylene oxide, preferably ethylene oxide, to alkyl phenols. Non-limiting examples are: Norfox® OP-102, Surfonic® OP-120, T-Det® 0-12.

Fatty acid ethoxylates are fatty acid esters, that are treated with different amounts of ethylene oxide.

Triglycerides are esters of glycerol (glycerides), in which all three hydroxyl groups are esterificated with fatty acids. These can be modified with alkylene oxides. Fatty acid alcohol amides comprise at least one amide group with an alkyl group and one or two alkoxyl groups. Alkyl polyglycosides are mixtures of alkyl monoglucosides (alkyl-α-D- and -β-D-glucopyranoside with a small amount-glucofuranoside), alkyl diglucosides (-isomaltosides, -maltosides and others) and alkyloligoglucosides (-maltotriosides,-tetraosides and others).

Alkyl polyglycosides can non-limiting be synthesized with an acid catalysed reaction (Fisher reaction) of glucose (or starch) or n-butylglycosides with fatty acid alcohols.

Further, also alkyl polyglycosides can be used as non-ionic surfactant. A non-limiting example is Lutensol® GD70. In addition, also non-ionic N-alkylated, preferably N-methylated, fatty acid amides can be used as surfactant.

Alcohol alkoxylates comprise a hydrophobic part with a chain length of 4 to 20 carbon atoms, preferably 6 to 19 C-atoms and more preferably 8 to 18 C-atoms, whereby the alcohol can be linear or branched, and a hydrophilic part that comprises alkoxylate units, such as ethylene oxide, propylene oxide and/or butylene oxide, with 2 to 30 repeating units. Non-limiting examples are: Lutensol® XP, Lutensol® XL, Lutensol® ON, Lutensol® AT, Lutensol® A, Lutensol® AO, Lutensol® TO.

Further, also, if desired and/or necessary, additives may be added during the production process of the emulsion. Additives can have a positive influence on the production process of the emulsion, and may provide certain desired characteristics to the emulsions. An example of possibly used additives are, inter alia, bases to optimize the saponification process, as well as bactericides, antimicrobial agents, dyes, viscosity modifiers for increase or reduction of the viscosity, anti-foaming agents, de-foaming agents. It should be clear to one skilled in the art that these are just examples of possibly used additives, and that other options are also possible.

In a fourth aspect, the present invention relates to a method to structure at least two immiscible fluid streams. This can for example be done to provide an aesthetically pleasing product. For food products it can also lead to a pleasing mixture of tastes.
providing at least two immiscible fluid streams,
combining said immiscible fluid streams to a focused total fluid stream, and
carrying out at least one baker's transformation on said total fluid stream, said baker's transformation comprises:
   i. stretching and cutting said total fluid stream;
   ii. recombining said total fluid stream.

The structure relates to fluid lamellae. These fluid lamellae can be structured around an axis. Furthermore, the fluid lamellae may make helical movements around said axis. This can be done to give aesthetically pleasing effects.

As the fluid lamellae in these structures are not required to collapse, but rather to be visible and discernable by the consumer, the repetition of several baker's transformation may be beneficial but is certainly not required.

In a preferred embodiment, the method according to the fourth aspect is used to mix several liquid phases with different colours. It can be used for pastes, sauces and similar products.

In a preferred embodiment, the fluids according to the fourth aspect of the invention are sufficiently viscous and/or yield stress fluids. In a more preferred embodiment, these fluids are yield stress fluids. This is beneficial to the stability of the structure which is produced. For example, by using yield stress fluids a stable structure can be produced and packaged with a long shelf life.

In a fifth aspect of the present invention, the invention relates to fluid structures produced by a method according to the fourth aspect of the present invention.

### EXAMPLES AND/OR DESCRIPTION OF FIGURES

The present invention is in no way limited to the embodiments described in the examples and/or shown in the figures. On the contrary, methods according to the present invention may be realized in many different ways without departing from the scope of the invention.

### Example 1

An emulsion of an oil phase based on polyisobutene (PiB) and an aqueous phase is created. The oil phase consists of 96% low molecular weight polyisobutene (Glissopal V190) and 4% isostearic acid. The aqueous phase consists of 15.7% water, 78.4% glycerine and 5.9% morpholine.

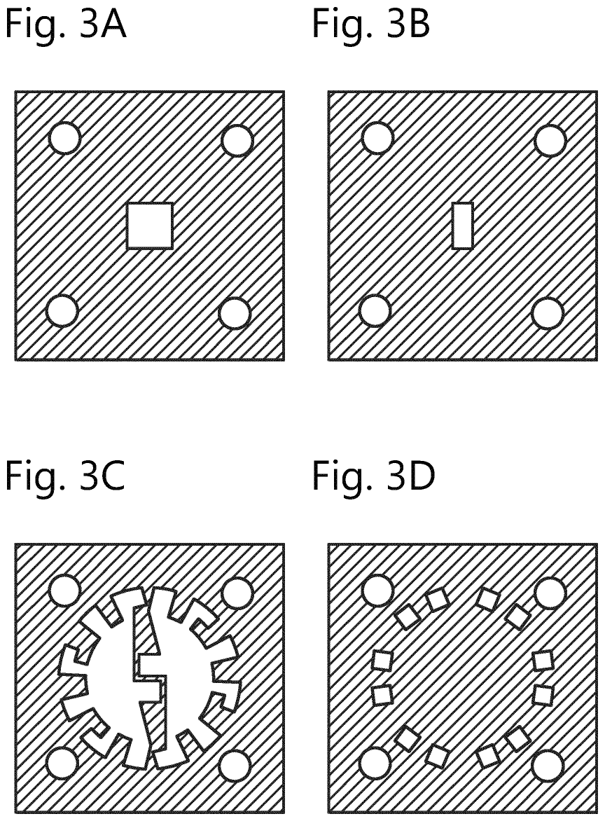

A static mixer suitable for viscous liquids according to U.S. Pat. No. 9,636,646 B2 is used. This mixer will be called the “Peelincx” mixer herein. This fractal mixer comprises stainless a series of steel plates in the appropriate geometry and dimensions and assembling these standard mixing plates into the correct order. The 4 base type plates for the layer multiplier are shown as FIGS. 3A-3D.

Each mixing subunit or splitter creates 12 new sublayers. In this example, the flow multiplier comprises 4 subsequent splitters. White spaces represent through openings, and the white circle in each corner are bores used when assembling several plates. The bores of all plates will line up, such that screw means or other clamping means may be arranged in the thus created through-opening. The plates of FIG. 3A and FIG. 3B are used to form the coupling between separate layer-multipliers. Sandwiching a plate of FIG. 3D between two plates according to FIG. 3C of which one is flipped as compared to the view of FIG. 3C will form a layer multiplier.

The resulting multi-layered structure was broken using the step-emulsification process. The crossflow at the end of the layer multiplier was accomplished by a similar set of plates shown in FIGS. 4A and 4B. In FIG. 4A, the multilayered structure flows through 1, with in this case the multi-layered structure oriented perpendicular to the longest side of 1, preferably by using this plate in conjunction with plate 3A. The crossflow of the desired continuous phase flows through section 2 of plate 4A. This results in a set of modular plates which can be combined into an assembly to create and collapse multilayered structures into emulsions continuously. In this example, 4 splitters followed by the crossflow assembly are used.

The layers of oil and water are then broken up, creating a dispersive mixture or emulsion. The layers are broken by inserting, perpendicular to the flow and the layers, an additional flow of the target continuous phase.

The flow rate of the oil phase into the static mixer was 4 ml/min. The flowrate of the aqueous phase was 1 ml/min. The flowrate of the aqueous phase in the crossflow channel for layer breakup was 3 ml/min. This resulted in an emulsion of the oil phase in the aqueous phase. The emulsion particle size was 1.28 μm as determined by laser diffraction.

### Example 2

Example 1 was repeated, with one additional splitter in the static mixer. The static mixer now comprises 5 subunits. The resulting emulsion of PiB in the aqueous phase had a particle size of 0.75 μm. It is expected that not enough stabilizer is present to stabilize smaller droplets.

### Example 3

Example 1 was repeated, with 4 splitters and surfactant and the addition of silica as colloids to further stabilizer the emulsion. The emulsion particle size was 3.5 μm.

### Example 4

Example 1 was repeated with 5 splitters. The layer multiplier now comprises 5 subunits. Furthermore, no surfactant was used but instead silica was added. The particle size was 11.2 μm.

### Examples 5-12

Polyisobutene emulsions were created with an AMK laboratory kneader VI U. These emulsions were created at a processing temperature of 90° C. The ingredients with the exception of water and biocide were first loaded into the kneader and mixed until homogenous. Water was then added at different rates while kneading as this was found to give the smallest particle sizes. In an initial phase, which lasts until 10% of the total amount of water was added, water was added at a rate of 2.5 g water/min/kg PiB. The second phase, which lasts until 20% of the total amount of water was added, water was added at a rate of 5 g water/min/kg PiB. In the last phase, water was added at a rate of 12.5 g water/min/kg PiB until the final concentration of water was reached. The produced emulsion is consequently cooled to ambient temperature, at which point the biocide is added.

The droplet distribution of examples 10-12 was investigated to evaluate the effect of tackifiers on the droplet distribution for PiB. Examples 10 and 12 comprise resin tackifier Regalite R1100. Example 11 comprises a rosin-based tackifier Foral 85E. In example 10, an emulsion was formed with a mean particle size of 1.04 μm.

The rotational viscosity of the emulsion measured with a LV-63 spindle was 1290 mPa·s at 20 RPM, 870 mPa·s at 50 rpm and 630 at 100 rpm. In example 11, an emulsion was formed. However the rosin did not appear to be fully compatible, that is to say miscible, with the PiB as segregated domains within PiB were formed. The mean particle size was 5.1 μm. In example 12, an emulsion was formed with a mean particle size of 1.3 μm. The rotational viscosity of the emulsion measured with a LV-63 spindle was 270 mPa·s at 20 RPM, 211 mPa·s at 50 rpm and 214 at 100 rpm.

The formulations for examples 5 to 12 are shown in Table 1.

TABLE 1
Examples 5-12

| | | | Water | | Additive |
|---|---|---|---|---|---|
| Example | PIB | Stabilizer | [%] | Wax/oil/resin | [%] |
| 5 | Oppanol | Morpholine | 30 | 0 | MBS |
| | B10 66.1% | isostearate | | | (biocide) |
| | | 3.8% | | | 0.1 |
| 6 | Oppanol | Morpholine | 30 | 0 | MBS |
| | B12 66.1% | isostearate | | | (biocide) |
| | | 3.8% | | | 0.1% |
| 7 | Oppanol | Morpholine | 30 | 0 | MBS |
| | B15 66.1% | isostearate | | | (biocide) |
| | | 3.8% | | | 0.1% |
| 8 | Tetrax 6T | Morpholine | 15.1 | 0 | MBS |
| | 78.9% | isostearate | | | (biocide) |
| | Glissopal SA | 3.8% | | | 0.1% |
| | 2.1% | | | | |
| 9 | Oppanol | Morpholine | 30 | 0 | MBS |
| | B12 66.1% | isostearate | | | (biocide) |
| | | 1.8% | | | 0.1% |
| | | Primacor | | | |
| | | 5980i | | | |
| | | 2.0% | | | |
| 10 | Oppanol | Morpholine | 38 | Regalite R1100 | MBS |
| | B10 43.9% | isostearate | | (resin) 14.6% | (biocide) |
| | | 3.4% | | | 0.1% |
| 11 | Oppanol | Morpholine | 38 | Foral 85 E resin) | MBS |
| | B10 43.9% | isostearate | | 14.6% | (biocide) |
| | | 3.4% | | | 0.1% |
| 12 | Himol 5.5 H | Morpholine | 37.9 | Regalite R1100 | MBS |
| | 37.1% | isostearate | | (resin) 5.7% | (biocide) |
| | Glissopal SA | 3.4% | | Microwax 5920-2 | 0.1% |
| | 1.5% | | | (wax) 14.3% | |

The mean particle size for examples 5-12 are shown in Table 2.

TABLE 2
Mean particle size in pm for examples 5-12

| Example | Mean particle size [μm] |
|---|---|
| Example 5 | 1.04 |
| Example 6 | 1.73 |
| Example 7 | 1.65 |
| Example 8 | 1.15 |
| Example 9 | 1.16 |
| Example 10 | 1.04 |
| Example 11 | 5.1 |
| Example 12 | 1.3 |

### Examples 13-15

The static mixer setup of example 1 comprising 5 splitters was used to create aqueous emulsions of PiB. The flow rates towards the layer multiplier was 0.3 ml/min water and 3 ml/min PiB. The crossflow channel comprised a flow of 0.4 ml/min water. 3.4% morpholine isostearate was added as stabilizer. After an emulsion was formed, 0.1% MBS as biocide was added.

Example 13 used Oppanol B10 as polyisobutene. The operating temperature was 90° C. An emulsion was formed.

Example 14 used Oppanol B15 as polyisobutene. The operating temperature was increased to 115° C. An emulsion was formed.

Example 15 used Tetrax 6T as polyisobutene. The operating temperature was 90° C. An emulsion was formed.

### Examples 16-19

The static mixer setup of example 1 comprising 4 splitters was used to create aqueous emulsions of hydrogenated vegetable oils, using water as the continuous phase. The flow rate into the layer multiplier was 0.7 ml/min for water and a flow rate for hydrogenated vegetable oil of 3.4 ml/min. An additional water flow rate of 1.2 ml/min was used as crossflow for the breakup of the multilayered structure. As stabilizer 4% silica was added to the hydrogenated vegetable oil. An emulsion was created, to which an 0.1% MBS was added after an emulsion was formed as biocide. The operating temperature was 65° C.

Example 16 used hydrogenated coconut oil. Example 17 used hydrogenated palm oil. Example 18 comprised hydrogenated rapeseed oil. Example 19 used a blend of 30% hydrogenated coconut oil and 70% hydrogenated rapeseed oil. In each case an emulsion was created.

### Example 20

An emulsion of an oil phase based on PIB and an aqueous phase is created according to the first aspect. The oil consists of 96% low molecular weight PIB (Glissopal V190) and 4% isostearic acid. The first aqueous phase to create the multi-layered structure consists of 5% ammonia and 95% water. The second water phase consists of 100% water.

A static mixer suitable for viscous liquids according to U.S. Pat. No. 9,636,646 B2 is used. The 4 base type plates for the layer multiplier are shown as FIGS. 3A-D. In this case, the base plates are machined in PMMA via laser cutting, with dimensions half of the dimensions of the mixer described in the examples of U.S. Pat. No. 9,636,646 B2. As in example 1, each subunit or splitter creates 12 new sublayers. The layer multiplier part of the static mixer is assembled by placing 6 splitters in series. The oil phase and the first aqueous phase are fed to his assembly at a flow rate of respectively 50 ml/min and 6.35 ml/min. The second aqueous phase is fed at a flow rate of 1.59 ml/min as a single layer perpendicular to the multi-layered structure to form liquid threads of PIB as shown in FIG. 2. These threads are broken into droplets by flowing the structure through 3 more splitters. The mean droplet size of the thus obtained emulsion was 8.4 μm.

### Examples 21-22

Following the preparation protocol of examples 5-12, aqueous polyisobutene emulsions with more than 65 wt. % polyisobutene were prepared. Example 21 was prepared at a processing temperature of 23° C. Examples 21 and 22 as shown in table 3, do not contain a wax, oil or resin.

TABLE 3
Composition and average particle size of examples 21-22

| | | | | | Mean |
|---|---|---|---|---|---|
| | | Stabilizer | Water | Additive | diameter |
| Example | PIB [wt. %] | [wt. %] | [wt. %] | [wt. %] | [μm] |
| Example | Glissopal V190 | Morpholine- | 28.7% | MBS | 0.39 |
| 21 | 65.5% + | isostearate | | (biocide) | |
| | Glissopal SA | 4.1% | | 0.1% | |
| | 1.6% | | | | |
| Example | Oppanol N50 | Morpholine- | 28.7% | MBS | 1.22 |
| 22 | 3.3% + Oppanol | isostearate | | (biocide) | |
| | B15 62.2% + | 4.1% | | 0.1% | |
| | Glissopal SA | | | | |
| | 1.6% | | | | |

### Examples 23-29

An emulsion based on Glissopal V190 (Polyisobutene, molecular weight of 1000 g/mol), is made with a nonionic surfactant, Lutensol T08. In a first step, a blend is made from polyisobutene and surfactant. Surfactant is added in an amount of 3.4% by weight of the polyisobutylene-surfactant-blend. The ratio polyisobutylene/surfactant is fixed, independent of the final water fraction in the emulsion. Different emulsions are made according to Table 4 with various contents of polyisobutylene. Emulsions, total mass 90 g, are prepared by the addition of the polyisobutylene-surfactant-blend to the water and subsequent homogenization with a rotor stator device (IKA Ultra Turax T25, 525N-10G dispersing tool, 9500 RPM, 5 minutes mixing).

TABLE 4
Composition and average particle size of examples 23-29

| | Water | Surfactant | Polyisobutylene | Mean diameter |
|---|---|---|---|---|
| | (wt %) | (wt %) | (wt %) | (μm) |
| Example | 50.2% | 1.7% | 48.1% | 27.3 |
| 23 | | | | |
| Example | 39.9% | 2.1% | 58.0% | 29.3 |
| 24 | | | | |
| Example | 35.0% | 2.2% | 62.7% | 19.2 |
| 25 | | | | |
| Example | 29.9% | 2.4% | 67.7% | 18.4 |
| 26 | | | | |
| Example | 25.0% | 2.6% | 72.4% | 2.9 |
| 27 | | | | |
| Example | 20.0% | 2.8% | 77.2% | 2.4 |
| 28 | | | | |
| Example | 15.0% | 2.9% | 82.0% | 1.4 |
| 29 | | | | |

Examples 23-29 resulted in polyisobutene-in-water emulsions. Emulsions prepared with less than 10% water following the same procedure inverted to water-in-polyisobutene emulsions during preparation.

### Examples 30-36

Emulsions with a high polyisobutene content were created following the procedure of example 1. However, a different polyisobutene composition was used. Instead of Glissopal V190, a blend of 10% Oppanol B15 (Molecular weight of 85 000 g/mol) in Glissopal V190 is used. Results are summarized in Table 5.

TABLE 5
Composition and average particle size of examples 30-36

| | Water | Surfactant | Polyisobutene | Mean diameter |
|---|---|---|---|---|
| | (wt. %) | (wt. %) | (wt. %) | (μm) |
| Example 30 | 50.1% | 1.5% | 48.3% | 58.4 |
| Example 31 | 39.7% | 1.8% | 58.5% | 49.9 |
| Example 32 | 35.2% | 2.0% | 62.8% | 46.2 |
| Example 33 | 30.0% | 2.2% | 67.8% | 42.4 |
| Example 34 | 24.9% | 2.3% | 72.9% | 26.1 |
| Example 35 | 19.9% | 2.4% | 77.7% | 6.6 |
| Example 36 | 15.2% | 2.8% | 82.1% | 4.7 |

### Examples 37-38

A polyisobutene in water emulsion is made using Glissopal V190 (Molecular weight of 1000 g/mol) and an anionic surfactant. The anionic surfactant consists of a fatty acid, Radiacid 907 from Oleon, and ammonia (amount corresponding to acid number of the fatty acid). In a first step, a blend is made from the fatty acid and the polyisobutylene. The fatty acid is added in an amount of 4% by weight of the polyisobutylene-fatty acid blend. The ratio polyisobutylene/fatty acid is fixed, independent of the final water fraction in the emulsion. Emulsions with different fraction of polyisobutylene are made according to Table 6. The polyisobutylene-fatty acid blend is added to the aqueous phase composed of the water and ammonia. Emulsions are then prepared with a flow-through rotor-stator device (IKA Process Pilot 2000/4 equipped with the colloid mill geometry, flow rate 200 I/h, gap setting 0.25 turn, 8000 RPM, operating temperature of 21° C., batch size 5 kg). After start-up, the emulsions are recycled for 2 min and then collected.

TABLE 6
Composition and average particle size of examples 37-38

| | | Ammonia | | | |
|---|---|---|---|---|---|
| | | (25% | Fatty | | Mean |
| | Water | solution) | acid | Polyisobutene | diameter |
| | (wt. %) | wt. %) | (wt. %) | (wt. %) | (μm) |
| Example 37 | 36.3% | 0.7% | 2.5% | 60.5% | 15.5 |
| Example 38 | 17.9% | 0.9% | 3.2% | 78.0% | 3.8 |

### Examples 39-40

The procedure of example 3 was repeated at an operating temperature of 75° C., with a different polyisobutene blend. The polyisobutene blend comprises 50 wt. % by weight of the polyisobutene blend of Oppanol B10 (Molecular weight 40 000 g/mol) and 50 wt. % by weight of the polyisobutene blend of Glissopal V1500 (Molecular weight 2300 g/mol). Results are summarized in Table 7.

TABLE 7
Composition and average particle size of examples 39-40

| | | Ammonia | Fatty | | Mean |
|---|---|---|---|---|---|
| | Water | (25% solution) | acid | Polyisobutylene | diameter |
| | (wt. %) | (wt. %) | (wt. %) | (wt. %) | (μm) |
| Example | 33.8% | 0.8% | 2.6% | 62.8% | 15.1 |
| 39 | | | | | |
| Example | 20.9% | 0.9% | 3.1% | 75.1% | 6.4 |
| 40 | | | | | |

### Example 41

A setup was created using 9 splitters as used in example 1, based on the base plates shown in FIGS. 3A, 3B, 3C and 3D. This setup was used to emulsify Glissopal V190 in water. 4 wt. % of stearic acid relative to the PiB phase was added to the PiB. 1 wt. % relative to the aqueous phase was added to the water stream. A flow rate of 4 ml/min of oil and 1 ml/min of water were used, creating an emulsion with 80% oil (PiB and stearic acid) and 20% aqueous phase (water and morpholine) was created. The morphology was evaluated under a microscope, showing striated flow and water droplets in oil at the exit of the first splitter as well as a fully emulsified solution with oil droplets in water after the ninth splitter. This emulsified solution at the end of the ninth splitter is called a premix. Its morphology showed oil drops of diameters ranging from 10 μm to 500 μm.

In a following setup, a side feed for water was provided along with the premix stream. The water stream could be adjusted up to a water volume fraction of 0.4.

The water-premix combination was passed through a single splitter for homogenization. The following flow was forced through 11 mesh elements as shown in FIGS. 5A and 5B, with 11 mesh elements shown in FIG. 3A in between. The mesh elements had conical passages with a tapered cross section. The maximum diameter Dₘₐₓ is 500 μm and the minimum diameter Dₘᵢₙ is 250 μm. The plates are 4 mm thick.

The resulting morphology was analyzed by microscopy, using more than 2000 particles, and by laser diffraction. The average diameter was 3.2 μm with a standard deviation of 1.76 according to microscope analysis. The average diameter obtained by laser diffraction is 3.9 μm. The entire process was carried out at room temperature, without heating any of the fluid streams or the setup itself.

### Example 42: Structuring Food Yield Stress Materials

Materials:
Phase 1: Commercial hazelnut paste Nutella®
Phase 2: Butter

Methods:

A fractal mixer, based on the spitting serpentine mixer, the so-called Dentincx mixer, is used to prepare a structured material. The structure of the Dentincx mixer is described in Neerincx et al, Macromol. Mater. Eng., 296 (2011) 349-361. The mixer is assembled from laser cut PMMA sheet of 5 mm thickness. The cut channels have a square cross section of 5×5 mm².

The mixer applies two sequential split-stretch-stack operations in one element. Starting from 2 layers, the mixer will create in total 8 layers (2×4¹).

Phase 1 and 2, loaded beforehand in two separate syringes, are fed to fractal mixer separately with a syringe pump from Harvard Apparatus. The connections from the syringe to the fractal mixer are made from Tygon tubing. Phase 1 is fed at 250 μl/min, whereas phase 2 is fed at 500 μl/min.

A completely straited and stable structure of 8 layers is obtained after extrusion. Stable is defined here as no change in layer thickness over time after collection of the material in a reservoir.

### Example 43: Structuring Cosmetic Yield Stress Materials

The same setup as in example 42 is used. The materials are now however a Nivea Crème and the same Nivea Cream died blue with Sudan Green. Again a 8 layered, stable structure is obtained. Both materials were fed at a flow rate of 500 μl/min.

### Example 44: Multicolored Toothpaste

A similar setup as in example 42 is used. The setup is modified by increasing the number of inlets from 2 to 3.

Materials:
Theramed 2 in 1 Original toothpaste: blue color
Theramed 2 in 1 Junior toothpaste: red color
Theramed 2 in 1 Whitening power: white color

The three toothpastes were fed at a rate of 400 μl/min. A multi-colored structure of 12 layers was obtained.

### Example 45: Emulsification of Eggs

Materials:

Whole eggs separated into phases:
Homogenized egg yolk
Homogenized egg white

Method:

A similar fractal mixer as in example 42 is used. It is however made from PMMA sheets of 2 mm thickness resulting in square channels of 2×2 mm². Furthermore, the mixer consists of 5 elements creating theoretically in total 2048 layers (2×4⁵) of submicron thickness. Layers of these thicknesses may be unstable depending on the process and material parameters, as shown for polymeric systems.

Both phases were fed to the mixer at equal flow rates of 1, 5 and 15 ml/min. Increasing the flow rate leads to more homogeneous and finer emulsions.

### Example 46: Emulsification: Formation of a Cosmetic Water-In-Oil Emulsion

Example of model cosmetic emulsion which can be used as a lotion, moisturizer or cream.

Materials:
Aqueous phase: mixture of glycerol-water-Tween 20-fluorescein in a weight ratios of 69-27.9-3-0.1
Oil phase: mixture of Vaseline®-Span 80 in a weight ratio of 97-3.
   This mixture is prepared at 70° C. and cooled to room temperature before use.

Method:

The same fractal mixer as in example 45 is used. A total flow rate of 2 ml/min is used (sum of flow rate of aqueous phase and oil phase). Emulsion differing in dispersed phase content are prepared by changing the ratio of aqueous to oil phase flow rates.

| | Aqueous | Oil phase | Macroscopic |
|---|---|---|---|
| Dispersed phase | phase flow | flow rate | stability (over |
| content (vol %) | rate (ml/min) | (ml/min) | 8 hr) |
| 10% | 0.2 | 1.8 | Stable |
| 30% | 0.6 | 1.4 | Stable |
| 50% | 1.0 | 1.0 | Stable |
| 70% | 1.4 | 0.6 | Unstable |

The dispersion were examined with brightfield, polarized and fluorescence microscopy. It revealed a hierarchal structure of different length scales:
Individual and clustered water droplets on the order of 1 μm.
Large (birefringent) wax crystals on the order of 100 μm.
At higher dispersed phase content, a quasi continuous structure is formed.

Different length scales can lead to different rheological and sensorial properties.

### Example 47: Emulsion Preparation: Mayonnaise

This examples shows how a yield-stress material can be obtained starting from low-viscous Newtonian liquids.

Materials:
Oil phase: rapeseed oil
Aqueous phase: mixture of egg-vinegar (7%)-water-mustard in a weight ratio of 58-14-14-14.

Methods:

The so-called Peelincx mixer is used to prepare mayonnaise. The mixer is assembled from laser cut plates shown in FIG. 3A-3D. 7 Peelincx elements are places in series. The oil is fed at a flow rate of 40 ml/min, the aqueous phase is fed at a flow rate of 10 ml/min.

The droplet size of the thus-obtained mayonnaise was further refined for long-term stability by applying a controlled extensional flow to the mayonnaise. This was achieved by flowing the material through conical orifices. In practice this was achieved by placing a laser cut plate as shown in FIG. 5A-5B after the Peelincx elements.

### Example 48: Gel Formation in Mixtures of Anionic and Zwitterionic Surfactant

This examples shows the preparation of a visco-elastic gel based on two aqueous solutions of a anionic and a zwitterionic surfactant useful in for example cosmetic (eg shampoo) formulations.

Materials:
Phase 1: aqueous solution of sodium laureth sulfate (25 wt %)
Phase 2: aqueous solution of cocamidopropyl betaine (25 wt %)

Methods:

The same fractal mixer as in example 45 is used. Both phases are fed to the mixer at equal flow rate of 1 ml/min. A homogeneous, shear-thinning gel is obtained.

### Example 49: Improved Efficiency of Butter Churning

In butter making, a heavy fat cream is converted into butter and buttermilk in a process called churning. During churning, the cream is mixed in a butter churn while air is gradually incorporated into the cream. Microscopically, two processes occur simultaneously: mixing leads to the aggregation of fat droplets, which is facilitated by the depletion of stabilizing proteins and lipid during the incorporation of air bubbles. The process continuous until the initial fat-in-water emulsion inverts to a water-in-fat emulsion (non-worked butter) and a non-dispersed aqueous phase (buttermilk).

This example shows that a fractal mixer can alter the microstructure of heavy cream leading to faster and thus more efficient butter churning.

Materials:
Heavy cream with a fat content of 35%.

Method:

The same fractal mixer as in example 45 was used to structure the heavy cream and precondition it for the churning process. A part of the cream was not processed as a reference. The cream was fed to the mixer at a rate of 32 ml/min. The processed cream was collected and processed a second time in the mixer under the same conditions. A third sample was made by recirculating the cream 20 time across the mixer. Between recirculation steps, air was introduced.

Evaluation:

Macroscopically no difference is seen between the processed and unprocessed cream, although the sample that has been processed 20×has a distinct higher viscosity. Brightfield microscopy reveals that the unprocessed cream is a fairly monodisperse emulsion, whereas the processed emulsions shows a higher polydispersity, larger and non-spherical droplets.

More efficient butter churning:
1. Churning by hand
   8 g of cream was placed in a 20 ml glass vial and vigorously shaken by hand. The samples were inspected every minute for phase separation; an indication of the formation of butter and buttermilk.
   The unprocessed sample required 5 minutes of shaking for phase separation to occur, whereas the sample processed twice required only 3 minutes. The sample processed 20× required 2 minutes for phase separation to occur.
2. Churning using a MCR 302 rheometer
   A helical impeller is used in combination with a couette cell. The samples are processed at a steady shear-rate of 100 s⁻¹ at 25° C. The shear stress as a function of time is recorded. The data is normalized by dividing the measured shear stress by the shear stress at time 0.
   Extended agglomeration (and thus butter formation) is detected by a sudden rise in relative shear stress. This parameter is more objective to detect than the visual phase separation by hand, the churning itself on a rheometer is less representative due to the mild mixing conditions and the lack of incorporation of air in the material.
   The unprocessed sample required 27 minutes before extended agglomeration started. The sample processed twice showed aggregation after just one minute of flow, reaching its plateau shear stress after 10 minutes. Surprisingly, the sample processed 20×, also required 26 minutes to show extended aggregation.

| | Time for churning | Time for churning with |
|---|---|---|
| Sample | by hand (min) | rheometer (min) |
| Unprocessed cream | 5 | 27 |
| Cream processed 2× | 3 | 10 |
| Cream processed 20× | 2 | 26 |

### Example 50: Working of Butter

The as obtained butter by hand shaking from example 8 requires further working to homogenize the water droplets and fat granules. The same fractal mixer as in example 45 is used. The butter was fed at a flow rate of 2 ml/min and passed 3 times across the mixer.

Additionally a concentrated salt (50%) solution can be added in the process to salt the butter at a flow rate of 0.04 ml/min during the first step.

### Example 51: Preparation of Margarine

Materials:

A margarine with a fat content of 82% was bought. It was phase separated into an aqueous phase and oil phase by gently heating it.

Methods:

The mixer of example 6 was used to emulsify the aqueous phase in the oil phase.

The aqueous phase was fed at a flow rate of 8.5 ml/min, whereas the oil phase was fed at 41.5 ml/min. After cooling, the solidified water-in-oil emulsion is passed 3× to same fractal mixer as used in example 45 at a flow rate of 2 ml/min to further homogenize the water droplets and crystal structure.

### Example 52: Structuring Food Yield Stress Materials

Materials:
Phase 1: Commercial mayonnaise
Phase 2: Commercial Dijon mustard

Methods:

A fractal mixer, based on the spitting serpentine mixer, the so-called Dentincx mixer, is used to prepare a structured material. The mixer is assembled from laser cut PMMA sheet of 5 mm thickness. The cut channels have a rectangular cross section of 4×5 mm².

The mixer applies two sequential split-stretch-stack operations in one element. Starting from 2 layers, the mixer will create in total 8 layers (2×41).

Phase 1 and 2, loaded beforehand in two separate syringes, are fed to fractal mixer separately with a syringe pump from Harvard Apparatus. The connections from the syringe to the fractal mixer are made from Tygon tubing. Phase 1 and phase 2 are both fed at 1 ml/min.

A completely straited structure of 8 layers is obtained upon extrusion into a reservoir. The structure is stable for multiple minutes, after which the extrudate flows under its own weight and the layers gradually lose fidelity.

### Example 53: Emulsification of Eggs

Materials:

Whole eggs separated into phases:
Homogenized egg yolk
Homogenized egg white

Method:

A similar fractal mixer as in example 47 is used. It is made from PMMA sheets of 4 mm thickness with a square combination channel (FIG. 3A) of 5×5 mm². The mixer consists of 5 elements and is fed by a tri-split feed, creating theoretically in total 746496 layers (3×12⁵) of nanometer order thickness. Layers become unstable before they reach these theoretical thicknesses. The point of instability depends on the process and material parameters, as shown for polymeric systems.

Both phases were fed to the mixer at equal flow rates of 1, 5 and 15 ml/min. Increasing the flow rate leads to more homogeneous and finer emulsions.

### Example 54: Nonionic Emulsion of Silicone Oil

Materials:
Oil phase: silicone oil of 100, 350 and 1000 cSt (Caldic Calsil IP 100, 350 and 1000 respectively)
Water phase: mixture of 2% Tween 80 and 2% Span 80 in water

Method:

The mixer of example 47 is used to prepare the emulsion. The oil flow rate is set at 63 ml/min and the water flow rate at 40 ml/min. Emulsions are obtained from each of the three silicone oils. After emulsification with the Peelincx mixer, the droplet is further refined by passing the emulsion through conical orifices as shown in FIG. 5A-5B at a flow fate of 100 ml/min.

### Example 55: Anionic Emulsion of (Cosmetic) Paraffin Oil and Paraffin Wax

Materials:
Oil phase: paraffin oil (INCI: Paraffinum liquidum) or paraffin wax 56-58 (INCI: Paraffin) mixed with 4% stearic acid (INCI: Stearic acid)
Water phase: solution of 0.1% KOH and 0.9% triethanolamine in water

Method:

The mixer of example 47 is used to prepare the emulsion. Emulsification is performed at 65° C., above the melting point of the stearic acid and/or paraffin wax. The oil flow rate is set at 50 ml/min and the water flow rate at 50 ml/min. After emulsification with the Peelincx mixer, the droplet is further refined by passing the emulsion through conical orifices as shown in FIG. 5A-5B at a flow fate of 120 ml/min. The emulsion is cooled to 25° C. by submersion into a water bath of 20° C.

### Example 56: Anionic Emulsion of Coconut Oil

Similar to example 55, an anionic emulsion of coconut oil is made by replacing the paraffin oil with coconut oil.

### Example 57: Formation of Emulsion Gels with Carboxymethylcellulose

Materials:
Phase 1: emulsions prepared in examples 54-56
Phase 2: solution of 2% carboxymethylcellulose in water

Method:

A Peelincx mixer similar as the one used in example 47 is used to prepare the emulsion gel, except that only 4 Peelincx elements are placed in series. Phase 1 is fed at 49 ml/min; phase 2 is fed at 1 ml/min. An emulsion gel is obtained.

### Example 58: Formation of Emulsion Gels with Xanthan-Guar Gum

Materials:
Phase 1: emulsions prepared in examples 54-56
Phase 2: solution of 1% xanthan gum in water
Phase 3: solution of 1% guar gum in water

Method:

Two Peelincx mixers as used in example 57 are used in series. The first Peelincx mixer is used to create the gel matrix by combining xanthan gum (phase 2) and guar gum (phase 3). Both phases are fed to the mixer at a flow rate of 0.5 ml/min. The outlet of the first Peelincx mixer is used directly to feed the second Peelincx mixer. As a second phase, phase 1 is fed at a rate of 49 ml/min. An emulsion gel is obtained.

1. Method for producing emulsions using a layer multiplayer comprising the steps of:
providing at least two immiscible fluid streams,
combining said immiscible fluid streams to a focused total fluid stream, and subsequently carrying out baker's transformations on said total fluid stream, said baker's transformation comprises:
i. stretching and cutting said total fluid stream;
ii. recombining said total fluid stream.

2. The method according to claim 1, wherein 3 to 10 subsequent baker's transformations are carried out.

3. The method according to claim 1, wherein said baker's transformation comprises:
i. stretching and cutting said total fluid stream; and
ii. stacking said total fluid stream.

4. The method according to claim 1 wherein said baker's transformation comprises:
i. stretching and cutting said total fluid stream; and
ii. folding said total fluid stream.

5. The method according to claim 1, wherein said total fluid stream flow in a layer multiplier with a cross sectional area, wherein i. stretching and cutting said total fluid stream is performed by tapering said cross sectional area.

6. The method according to claim 1, wherein an average cross-sectional area (Aavl as measured by method A is between 10⁻⁷ mm2 and 10⁻³ mm².

7. The method according to claim 1, further comprising the step of:
gradually tapering the crossflow section of said focused total fluid stream in the direction of the flow from a first crossflow section area A₁ to a second crossflow section A₂, wherein the first crossflow section area A₁ is larger than the second crossflow section area A₂, and
abruptly expanding said second crossflow section area A₂ to a third crossflow section area A₃, wherein said third crossflow section is equal or larger than said second cross flow section area A₂.

8. The method according to claim 7, wherein the gradual tapering of the crossflow section and the abrupt expansion is performed after said baker's transformations.

9. The use of a method according to claim 1 to produce food grade emulsions.

10. The use according to claim 9 to produce a food grade emulsion chosen from the list of: margarine, dairy products preferably butter or milk, and sauces and dressings preferably vinaigrette or mayonnaise.

11. The use of a method according to claim 1 to produce cosmetic or pharmaceutical emulsions.

12. An emulsion obtained by a method according to claim 1.

13. A food grade, cosmetic or pharmaceutical emulsion obtained by a method according to claim 1.

14. Method to structure at least two immiscible fluid streams, comprising the steps of:
providing at least two immiscible fluid streams,
combining said immiscible fluid streams to a focused total fluid stream, and
carrying out at least one baker's transformation on said total fluid stream, said baker's transformation comprises:
i. stretching and cutting said total fluid stream;
ii. recombining said total fluid stream.

15. The method of claim 14 wherein at least one of said immiscible fluid streams comprises a yield stress fluid.
